(19) United States
(12) Patent Application Publication
(10) Pub. No.: US 2024/0377616 A1
(43) Pub. Date: Nov. 14, 2024

(54) OPTICAL SYSTEM AND CAMERA MODULE COMPRISING SAME

(71) Applicant: LG INNOTEK CO., LTD., Seoul (KR)

(72) Inventor: Young Hwan CHOI, Seoul (KR)

(21) Appl. No.: 18/577,413

(22) PCT Filed: Jul. 11, 2022
(86) PCT No.: PCT/KR2022/010067

§ 371 Date: Jan. 8, 2024

(30) Foreign Application Priority Data
Jul. 9, 2021 (KR) 10-2021-0090479

(51) Int. Cl. G02B 9/64; G02B 13/18

(52) U.S. Cl. CPC G02B 9/64; G02B 13/18

(57) ABSTRACT

The optical system disclosed in the embodiment of the invention includes first to ninth lenses disposed along an optical axis from an object side toward a sensor side, the first lens has positive refractive power on the optical axis, and the seventh lens has a positive (+) refractive power on the optical axis, the ninth lens has a negative (−) refractive power on the optical axis, and the seventh lens may be a thickest among thicknesses of each of the first to ninth lenses in the optical axis.

### TECHNICAL FIELD

An embodiment relates to an optical system for improved optical performance and a camera module comprising same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses. In addition, the size of the image sensor is increasing to realize high-resolution and high-definition. However, when the size of the image sensor increases, the TTL (Total Track Length) of the optical system including the plurality of lenses also increases, thereby increasing the thickness of the camera and the mobile terminal including the optical system. Therefore, a new optical system capable of solving the above problems is required.

[Disclosure] [Technical Problem]

An embodiment of the invention provides an optical system with improved optical properties. The embodiment provides an optical system having excellent optical performance at the center portion and periphery portions of the field of view. The embodiment provides an optical system capable of having a slim structure.

### Technical Solution

An optical system according to an embodiment of the invention comprises first to ninth lenses disposed along an optical axis from an object side toward a sensor side, the first lens has positive (+) refractive power on the optical axis, and the seventh lens has a positive (+) refractive power on the optical axis, the ninth lens has a negative (−) refractive power on the optical axis, and the seventh lens may be a thickest among thicknesses of each of the first to ninth lenses in the optical axis.

The seventh lens may satisfy the following equation: 0<L7_ET/L7_CT<1 (L7_CT is the thickness of the seventh lens in the optical axis, L7_ET is a distance in an optical axis direction between an end of an effective region of an object-side surface of the seventh lens and an end of an effective region of a sensor-side surface of the seventh lens).

In addition, the object-side surface of the seventh lens may have a convex shape and the sensor-side surface may have a convex shape on the optical axis. A refractive index of the seventh lens may be greater than 1.6. The first lens or the third lens may have a smallest effective diameter (clear aperture) among the first to ninth lenses. The sensor-side surface of the first lens may function as an aperture stop.

The optical system according to the embodiment includes first to ninth lenses disposed along an optical axis from an object side toward the sensor side, the first lens has positive (+) refractive power on the optical axis, and the seventh lens has a positive (+) refractive power on the optical axis, the ninth lens has a negative (−) refractive power on the optical axis, and the seventh and ninth lenses may satisfy the following equation: 1<L7_CT/L9_CT<3 (L7_CT is a thickness of the seventh lens in the optical axis, and L9_CT is a thickness of the ninth lens in the optical axis).

The seventh lens may be a thickest among thicknesses of each of the first to ninth lenses in the optical axis.

The eighth lens may satisfy the following equation: 0.2<L8_CT/L8_ET<1 (L8_CT is the thickness of the eighth lens in the optical axis, L8_ET is a distance in an optical axis direction between an end of an effective region of an object-side surface of the eighth lens and an end of an effective region of a sensor-side surface of the eighth lens).

The object-side surface of the eighth lens may have a concave shape. The seventh and eighth lenses may satisfy the following equation: 1.4<L7_CT/L8_CT<3.5 (L7_CT is the thickness of the seventh lens in the optical axis, and L8_CT is the thickness of the eighth lens in the optical axis).

In addition, when the optical axis is a starting point and an end of the effective region of the sensor-side surface of the seventh lens is an end point, a distance in an optical axis direction between the seventh and eighth lenses increases from the optical axis to a seventh point located on a sensor-side surface of the seventh lens, decreases from the seventh point to a eighth point located on the sensor-side surface of the seventh lens, and the eighth point may be the end of the effective region of the sensor-side surface of the seventh lens. In addition, the seventh point may be disposed at a position that is 60% to 90% of an effective radius of the sensor-side surface of the seventh lens.

In addition, when the optical axis is a starting point and an end of an effective region of a sensor-side surface of the seventh lens is an end point, an optical axis distance between the seventh and eighth lenses increases from the optical axis to a seventh point located on the sensor-side surface of the seventh lens, decreases from the seventh point to a eighth point located on the sensor-side surface of the seventh lens, decreases from the eighth point to a ninth point located on the sensor-side surface of the seventh lens, and the ninth point may be the end of the effective region on the sensor-side surface of the seventh lens.

In addition, the seventh point may be located at a position that is 50% to 70% of the effective radius of the sensor-side surface of the seventh lens with respect to the optical axis, and the eighth point may be located at a position that is 80% to 95% of the effective radius of the sensor-side surface of the seventh lens.

An optical system according to the embodiment includes first to ninth lenses disposed along an optical axis from an object side toward a sensor side, and an aperture stop disposed between the first and second lenses, the first lens disposed between the object and the aperture stop is defined as a first lens group, and the second to ninth lenses disposed between the aperture stop and the sensor are defined as a second lens group, and each of the first lens group and the second lens group may have a value of positive focal length.

In addition, the first and second lens groups may satisfy the following equation: 5<f_G1/f_G2<20 (f_G1 is a focal length of the first lens group, and f_G2 is a focal length of the second lens group). The seventh lens may have a thickest thickness among thicknesses of each of the first to ninth lenses in the optical axis.

A camera module according to an embodiment may include the optical system and satisfy the following equation: 3<F/BFL<8 (F is a total focal length of the optical system, and BFL (Back focal length) is a distance in the optical axis between a sensor-side surface closest to the sensor to an image surface of the sensor).

### Advantageous Effects

The optical system and camera module according to the embodiment may have improved optical characteristics. In detail, the optical system may have improved resolution as the plurality of lenses have a set shape, refractive power, thickness, distance, etc. The optical system and camera module according to the embodiment may have improved chromatic aberration, distortion, and aberration control characteristics, and may have good optical performance not only in the center portion but also in the periphery portion of the field of view (FOV).

The optical system according to the embodiment may have improved optical characteristics and a small TTL (Total Track Length), so the optical system and the camera module including the same may be provided in a slim and compact structure.

### DESCRIPTION OF DRAWINGS

FIG. 1 is a configuration diagram of an optical system according to a first embodiment.

FIG. 2 is a MTF graph for spatial frequency of an optical system according to the first embodiment.

FIG. 3 is a graph of the diffraction MTF of the optical system according to the first embodiment.

FIG. 4 is an aberration diagram of an optical system according to the first embodiment.

FIG. 5 is a configuration diagram of an optical system according to the second embodiment.

FIG. 6 is a MTF graph for spatial frequency of the optical system according to the second embodiment.

FIG. 7 is a graph of the diffraction MTF of the optical system according to the second embodiment.

FIG. 8 is an aberration diagram of an optical system according to the second embodiment.

FIG. 9 is a configuration diagram of an optical system according to the third embodiment.

FIG. 10 is a MTF graph for spatial frequency of the optical system according to the third embodiment.

FIG. 11 is a graph of the diffraction MTF of the optical system according to the third embodiment.

FIG. 12 is an aberration diagram of an optical system according to the third embodiment.

FIG. 13 is a diagram showing a camera module according to an embodiment applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C.

In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A radius of curvature, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method.

The optical system 1000 according to the embodiment may include a plurality of lenses 100. For example, the optical system 1000 may include five or more lenses. In detail, the optical system 1000 may include eight or more lenses. The optical system 1000 may include nine lenses. The plurality of lenses 100 may include a first lens 110, a second lens 120, a third lens 130, a fourth lens 140, a fifth lens 150, a sixth lens 160, a seventh lens 170, an eighth lens 180, and a ninth lens 190 which are sequentially arranged from the object side to the image sensor 300. The first to ninth lenses 110, 120, 130, 140, 150, 160, 170, 180, and 190 may be sequentially arranged along the optical axis OA of the optical system 1000. Light corresponding to the information of the object may pass through the first lens 110, the second lens 120, the third lens 130, the fourth lens 140, the fifth lens 150, the sixth lens 160, the seventh lens 170, the eighth lens 180, and the ninth lens 190 to enter the image sensor 300.

Each of the plurality of lenses 100 may include an effective region and a non-effective region. The effective region may be a region through which light incident on each of the first to ninth lenses 110, 120, 130, 140, 150, 160, 170, 180, and 190 passes. That is, the effective region may be a region in which the incident light is refracted to implement optical characteristics. The non-effective region may be arranged around the effective region. The non-effective region may be a region where light does not enter the plurality of lenses 100. That is, the non-effective region may be a region unrelated to the optical characteristics. Additionally, the non-effective region may be a region fixed to a barrel (not shown) that accommodates the lens.

The optical system 1000 may include an image sensor 300. The image sensor 300 may detect light. In detail, the image sensor 300 may detect the light that sequentially passes through the plurality of lenses 100. The image sensor 300 may include an element capable of detecting incident light, such as a charge coupled device (CCD) or a complementary metal oxide semiconductor (CMOS).

The optical system 1000 according to the embodiment may further include a filter 500. The filter 500 may be disposed between the plurality of lenses 100 and the image sensor 300. The filter 500 may be disposed between the image sensor 300 and the last lens disposed closest to the image sensor 300 among the plurality of lenses 100. For example, when the optical system 100 includes a nine lens, the filter 500 may be disposed between the ninth lens 190 and the image sensor 300. The filter 500 may include at least one of optical filters such as an infrared filter and a cover glass. The filter 500 may pass light in a set wavelength band and filter light in a different wavelength band. When the filter 500 includes an infrared filter, radiant heat emitted from external light may be blocked from being transmitted to the image sensor 300. Additionally, the filter 500 may transmit visible light and reflect infrared rays.

The optical system 1000 according to the embodiment may include an aperture stop (not shown). The aperture stop may control the amount of light incident on the optical system 1000. The aperture stop may be disposed at a set position. For example, the aperture stop may be located in front of the plurality of lenses 100 adjacent to the object or behind the plurality of lenses 100. Additionally, the aperture stop may be disposed between two lenses selected from among the plurality of lenses 100. For example, the aperture stop may be located between the first lens 110 and the second lens 120. Alternatively, at least one lens selected from among the plurality of lenses 100 may function as an aperture stop. In detail, the object-side surface or the sensor-side surface of one lens selected from among the first to ninth lenses 110, 120, 130, 140, 150, 160, 170, 180, and 190 may serves as an aperture stop to control the amount of light. For example, the sensor-side surface (second surface S2) of the first lens 110 may function as an aperture stop.

The plurality of lenses 100 may be divided into one or plural lens groups based on the aperture stop. In detail, when the aperture stop is located between two adjacent lenses among a plurality of lenses 100, at least one lens disposed between the object and the aperture stop may be defined as a first lens group G1, and at least one lens disposed between the aperture stop and the image sensor 300 may be defined as a second lens group G2. For example, the aperture stop is disposed between the first lens 110 and the second lens 120, or the sensor-side surface (second surface S2) of the first lens 110 may serve as an aperture stop. In this case, the first lens 110 may be defined as the first lens group G1, and the second to ninth lenses 120, 130, 140, 150, 160, 170, 180, and 190 may be defined as the second lens group G2.

The optical system 1000 may include at least one optical path changing member (not shown). The optical path changing member may change the path of light by reflecting light incident from the outside. The optical path changing member may include a reflector or prism. For example, the optical path changing member may include a right-angled prism. When the optical path changing member includes a right-angled prism, the optical path changing member may change the path of light by reflecting the path of incident light at an angle of 90 degrees. The optical path changing member may be disposed closer to the object than the plurality of lenses 100. That is, when the optical system 1000 includes one optical path changing member, the optical path changing member, the first lens 110, the second lens 120, and the third lens 130, fourth lens 140, fifth lens 150, sixth lens 160, seventh lens 170, eighth lens 180, ninth lens 190, filter 500 and image sensors 300 may be arranged in order from the object side toward the sensor. Alternatively, the optical path changing member may be disposed between the plurality of lenses 100. For example, the optical path changing member may be disposed between the nth lens and the n+1th lens. Alternatively, the optical path changing member may be disposed between the plurality of lenses 100 and the image sensor 300. The optical path changing member may change the path of light incident from the outside in a set direction. For example, when the optical path changing member is disposed closer to the object than the plurality of lenses 100, the optical path changing member may change the path of light incident on the optical path changing member in the first direction to the second direction, which is the arrangement direction (a direction in which the plurality of lenses 100 are spaced apart is the optical axis OA direction in the drawing) of the plurality of lenses 100.

When the optical system 1000 includes an optical path changing member, the optical system may be applied to a folded camera that may reduce a thickness of the camera. In detail, when the optical system 1000 includes the optical path changing member, light incident in a direction perpendicular to the surface of the device to which the optical system 1000 is applied may be changed to a direction parallel to the surface of the device. Accordingly, the optical system 1000 including a plurality of lenses 100 may have a thinner thickness within the device, so the device may be provided thinner. For example, when the optical system 1000 does not include the optical path changing member, the plurality of lenses 100 may be disposed within the device, extending in a direction perpendicular to the surface of the device. Accordingly, the optical system 1000 including the plurality of lenses 100 has a high height in a direction perpendicular to the surface of the device, and because of this, it may be difficult to make the optical system 1000 and the device including it thin.

However, when the optical system 1000 includes the optical path changing member, the plurality of lenses 100 may be arranged to extend in a direction parallel to the surface of the device. That is, the optical system 1000 is arranged so that the optical axis OA is parallel to the surface of the device and may be applied to a folded camera. Accordingly, the optical system 1000 including the plurality of lenses 100 may have a low height in a direction perpendicular to the surface of the device. Accordingly, the camera including the optical system 1000 may have a thin thickness within the device, and the thickness of the device may also be reduced.

Hereinafter, the plurality of lenses 100 according to the embodiment will be described in more detail.

The first lens 110 may have positive (+) refractive power on the optical axis OA. The first lens 110 may include plastic or glass. For example, the first lens 110 may be made of plastic. The first lens 110 may include a first surface S1 defined as the object-side surface and a second surface S2 defined as the sensor-side surface. The first surface S1 may have a convex shape on the optical axis OA, and the second surface S2 may have a concave shape on the optical axis OA. That is, the first lens 110 may have a meniscus shape that is convex toward the object on the optical axis OA. Alternatively, the first surface S1 may have a convex shape on the optical axis OA, and the second surface S2 may have a convex shape on the optical axis OA. That is, the first lens 110 may have a shape in which both sides are convex on the optical axis OA. At least one of the first surface S1 and the second surface S2 may be an aspherical surface. For example, both the first surface S1 and the second surface S2 may be aspherical.

The second lens 120 may have positive (+) or negative (−) refractive power on the optical axis OA. The second lens 120 may include plastic or glass. For example, the second lens 120 may be made of plastic. The second lens 120 may include a third surface S3 defined as the object-side surface and a fourth surface S4 defined as the sensor-side surface. The third surface S3 may have a convex shape on the optical axis OA, and the fourth surface S4 may have a concave shape on the optical axis OA. That is, the second lens 120 may have a meniscus shape that is convex toward the object on the optical axis OA. Alternatively, the third surface S3 may have a convex shape on the optical axis OA, and the fourth surface S4 may have a convex shape on the optical axis OA. That is, the second lens 120 may have a shape in which both sides are convex on the optical axis OA. Alternatively, the third surface S3 may have a concave shape on the optical axis OA, and the fourth surface S4 may have a convex shape on the optical axis OA. That is, the second lens 120 may have a meniscus shape that is convex on the optical axis OA toward the image sensor 300. Alternatively, the third surface S3 may have a concave shape on the optical axis OA, and the fourth surface S4 may have a concave shape on the optical axis OA. That is, the second lens 120 may have a shape in which both sides are concave of the optical axis OA. At least one of the third surface S3 and the fourth surface S4 may be an aspherical surface. For example, both the third surface S3 and the fourth surface S4 may be aspherical.

The third lens 130 may have positive (+) or negative (−) refractive power on the optical axis OA. The third lens 130 may include plastic or glass. For example, the third lens 130 may be made of plastic. The third lens 130 may include a fifth surface S5 defined as the object-side surface and a sixth surface S6 defined as the sensor-side surface. The fifth surface S5 may have a convex shape on the optical axis OA, and the sixth surface S6 may have a concave shape on the optical axis OA. That is, the third lens 130 may have a meniscus shape that is convex on the optical axis OA toward the object. Alternatively, the fifth surface S5 may have a convex shape on the optical axis OA, and the sixth surface S6 may have a convex shape on the optical axis OA. That is, the third lens 130 may have a shape in which both sides are convex on the optical axis OA. Alternatively, the fifth surface S5 may have a concave shape on the optical axis OA, and the sixth surface S6 may have a convex shape on the optical axis OA. That is, the third lens 130 may have a meniscus shape convex toward the image sensor 300. Alternatively, the fifth surface S5 may have a concave shape on the optical axis OA, and the sixth surface S6 may have a concave shape on the optical axis OA. That is, the third lens 130 may have a shape in which both sides are concave on the optical axis OA. At least one of the fifth surface S5 and the sixth surface S6 may be an aspherical surface. For example, both the fifth surface S5 and the sixth surface S6 may be aspherical.

The fourth lens 140 may have positive (+) or negative (−) refractive power on the optical axis OA. The fourth lens 140 may include plastic or glass. For example, the fourth lens 140 may be made of plastic. The fourth lens 140 may include a seventh surface S7 defined as the object-side surface and an eighth surface S8 defined as the sensor-side surface. The seventh surface S7 may have a convex shape on the optical axis OA, and the eighth surface S8 may have a concave shape on the optical axis OA. That is, the fourth lens 140 may have a meniscus shape that is convex on the optical axis OA toward the object. Alternatively, the seventh surface S7 may have a convex shape on the optical axis OA, and the eighth surface S8 may have a convex shape on the optical axis OA. That is, the fourth lens 140 may have a shape in which both sides are convex on the optical axis OA. Alternatively, the seventh surface S7 may have a concave shape on the optical axis OA, and the eighth surface S8 may have a convex shape on the optical axis OA. That is, the fourth lens 140 may have a meniscus shape that is convex on the optical axis OA toward the image sensor 300. Alternatively, the seventh surface S7 may have a concave shape on the optical axis OA, and the eighth surface S8 may have a concave shape on the optical axis OA. That is, the fourth lens 140 may have a shape in which both sides are concave of the optical axis OA. At least one of the seventh surface S7 and the eighth surface S8 may be an aspherical surface. For example, both the seventh surface S7 and the eighth surface S8 may be aspherical.

The fifth lens 150 may have positive (+) or negative (−) refractive power on the optical axis OA. The fifth lens 150 may include plastic or glass. For example, the fifth lens 150 may be made of plastic. The fifth lens 150 may include a ninth surface S9 defined as the object-side surface and a tenth surface S10 defined as the sensor-side surface. The ninth surface S9 may have a convex shape on the optical axis OA, and the tenth surface S10 may have a concave shape on the optical axis OA. That is, the fifth lens 150 may have a meniscus shape that is convex on the optical axis OA toward the object. Alternatively, the ninth surface S9 may have a convex shape on the optical axis OA, and the tenth surface S10 may have a convex shape on the optical axis OA. That is, the fifth lens 150 may have a shape in which both sides are convex on the optical axis OA. Alternatively, the ninth surface S9 may have a concave shape on the optical axis OA, and the tenth surface S10 may have a convex shape on the optical axis OA. That is, the fifth lens 150 may have a meniscus shape convex on the optical axis OA toward the image sensor 300. Alternatively, the ninth surface S9 may have a concave shape on the optical axis OA, and the tenth surface S10 may have a concave shape on the optical axis OA. That is, the fifth lens 150 may have a shape in which both sides are concave of the optical axis OA. At least one of the ninth surface S9 and the tenth surface S10 may be an aspherical surface. For example, both the ninth surface S9 and the tenth surface S10 may be aspherical.

The sixth lens 160 may have positive (+) or negative (−) refractive power on the optical axis OA. The sixth lens 160 may include plastic or glass. For example, the sixth lens 160 may be made of plastic. The sixth lens 160 may include an eleventh surface S11 defined as the object-side surface and a twelfth surface S12 defined as the sensor-side surface. The eleventh surface S11 may have a convex shape on the optical axis OA, and the twelfth surface S12 may have a concave shape on the optical axis OA. That is, the sixth lens 160 may have a meniscus shape that is convex on the optical axis OA toward the object. Alternatively, the eleventh surface S11 may have a convex shape on the optical axis OA, and the twelfth surface S12 may have a convex shape on the optical axis OA. That is, the sixth lens 160 may have a shape in which both sides are convex on the optical axis OA. Alternatively, the eleventh surface S11 may have a concave shape on the optical axis OA, and the twelfth surface S12 may have a convex shape on the optical axis OA. That is, the sixth lens 160 may have a meniscus shape that is convex on the optical axis OA toward the image sensor 300. Alternatively, the eleventh surface S11 may have a concave shape on the optical axis OA, and the twelfth surface S12 may have a concave shape on the optical axis OA. That is, the sixth lens 160 may have a shape in which both sides are concave of the optical axis OA. At least one of the eleventh surface S11 and the twelfth surface S12 may be an aspherical surface. For example, both the eleventh surface S11 and the twelfth surface S12 may be aspherical.

The seventh lens 170 may have positive (+) or negative (−) refractive power on the optical axis OA. The seventh lens 170 may include plastic or glass. For example, the seventh lens 170 may be made of plastic. The seventh lens 170 may include a thirteenth surface S13 defined as the object-side surface and a fourteenth surface S14 defined as the sensor-side surface. The thirteenth surface S13 may have a convex shape on the optical axis OA, and the fourteenth surface S14 may have a convex shape on the optical axis OA. That is, the seventh lens 170 may have a shape in which both sides are convex on the optical axis OA. Alternatively, the thirteenth surface S13 may have a concave shape on the optical axis OA, and the fourteenth surface S14 may have a convex shape on the optical axis OA. That is, the seventh lens 170 may have a meniscus shape convex on the optical axis OA toward the image sensor 300. At least one of the thirteenth surface S13 and the fourteenth surface S14 may be an aspherical surface. For example, both the thirteenth surface S13 and the fourteenth surface S14 may be aspherical.

The eighth lens 180 may have positive (+) or negative (−) refractive power on the optical axis OA. The eighth lens 180 may include plastic or glass. For example, the eighth lens 180 may be made of plastic. The eighth lens 180 may include a fifteenth surface S15 defined as the object-side surface and a sixteenth surface S16 defined as the sensor-side surface. The fifteenth surface S15 may have a convex shape on the optical axis OA, and the sixteenth surface S16 may have a concave shape on the optical axis OA. That is, the eighth lens 180 may have a meniscus shape convex on the optical axis OA toward the object. Alternatively, the fifteenth surface S15 may have a convex shape on the optical axis OA, and the sixteenth surface S16 may have a convex shape on the optical axis OA. That is, the eighth lens 180 may have a shape in which both sides are convex on the optical axis OA. Alternatively, the fifteenth surface S15 may have a concave shape on the optical axis OA, and the sixteenth surface S16 may have a convex shape on the optical axis OA. That is, the eighth lens 180 may have a meniscus shape that is convex on the optical axis OA toward the image sensor 300. Alternatively, the fifteenth surface S15 may have a concave shape on the optical axis OA, and the sixteenth surface S16 may have a concave shape on the optical axis OA. That is, the eighth lens 180 may have a shape in which both sides are concave of the optical axis OA. At least one of the fifteenth surface S15 and the sixteenth surface S16 may be an aspherical surface. For example, both the fifteenth surface S15 and the sixteenth surface S16 may be aspherical.

The eighth lens 180 may include at least one inflection point. In detail, at least one of the fifteenth surface S15 and the sixteenth surface S16 may include an inflection point. Here, the inflection point may mean a point where a slope of a tangent line on at least one of the fifteenth surface S15 and the sixteenth surface S16 is 0. The inflection point is a point at which the optical axis OA and the slope value with respect to the direction perpendicular to the optical axis OA change from positive (+) to negative (−) or from negative (−) to positive (+) on the lens surface and may mean a point at which the slope value is 0. The eighth lens 180 may include a first inflection point (not shown) disposed in the sixteenth surface S16. The first inflection point may be located at a position of about 40% to about 85% when the optical axis OA is a starting point and the effective region of the sixteenth surface S16 of the eighth lens 180 is an end point. In detail, the first inflection point may be located at a position that is about 50% to about 80% of the effective radius of the sixteenth surface S16 of the eighth lens 180 based on the optical axis OA as the starting point. Here, the position of the first inflection point is a position set based on a direction perpendicular to the optical axis OA, and may mean a straight distance from the optical axis OA to the first inflection point. It is preferable that the position of the first inflection point satisfies the above-described range in consideration of the optical characteristics of the optical system 1000. In detail, it is desirable that the position of the first inflection point satisfies the above-mentioned range for controlling the distortion and aberration characteristics of the optical system 1000. Accordingly, the optical system 1000 may have improved optical performance in the center and peripheral portions of the field of view (FOV). Here, the effective radius of each lens surface is the optical axis as the starting point, the end of each lens surface as the end point, and the distance between the starting and ending points.

The ninth lens 190 may have negative refractive power on the optical axis OA. The ninth lens 190 may include plastic or glass. For example, the ninth lens 190 may be made of plastic. The ninth lens 190 may include a seventeenth surface S17 defined as the object-side surface and an eighteenth surface S18 defined as the sensor-side surface. The seventeenth surface S17 may have a convex shape on the optical axis OA, and the eighteenth surface S18 may have a concave shape on the optical axis OA. That is, the ninth lens 190 may have a meniscus shape that is convex on the optical axis OA toward the object. Alternatively, the seventeenth surface S17 may have a concave shape on the optical axis OA, and the eighteenth surface S18 may have a concave shape on the optical axis OA. That is, the ninth lens 190 may have a shape in which both sides are concave of the optical axis OA. At least one of the seventeenth surface S17 and the eighteenth surface S18 may be an aspherical surface. For example, both the seventeenth surface S17 and the eighteenth surface S18 may be aspherical.

The ninth lens 190 may include at least one inflection point. In detail, at least one of the seventeenth surface S17 and the eighteenth surface S18 may include an inflection point. Here, the inflection point may mean a point where the slope of the tangent line on at least one of the seventeenth surface S17 and the eighteenth surface S18 is 0. The inflection point is a point at which the optical axis OA and the slope value with respect to the direction perpendicular to the optical axis OA change from positive (+) to negative (−) or from negative (−) to positive (+) on the lens surface and may mean a point where the slope value is 0. The ninth lens 190 may include a second inflection point (not shown) disposed in the seventeenth surface S17. The second inflection point may be disposed at a position that is about 15% to about 60% of the effective radius of the seventeenth surface S17 of the ninth lens 190 with respect to the optical axis OA. In detail, the second inflection point may be located at a position that is about 20% to about 50% of the effective radius of the seventeenth surface S17 of the ninth lens 190 with respect to the optical axis OA. Here, the position of the second inflection point is a position set based on a direction perpendicular to the optical axis OA and may mean a straight distance from the optical axis OA to the second inflection point.

The ninth lens 190 may include a third inflection point (not shown) disposed in the eighteenth surface S18. The third inflection point may be disposed at a position that is about 30% to about 80% of the effective radius of the eighteenth surface S18 of the ninth lens 190 with respect to the optical axis OA. In detail, the third inflection point may be located at a position that is about 35% to about 65% of the effective radius of the eighteenth surface S18 of the ninth lens 190 with respect to the optical axis OA. Here, the position of the third inflection point is a position set based on a direction perpendicular to the optical axis OA, and may mean a straight distance from the optical axis OA to the third inflection point.

It is preferable that the positions of the second and third inflection points satisfy the above-described range in consideration of the optical characteristics of the optical system 1000. In detail, it is desirable that the positions of the second and third inflection points satisfy the above-mentioned range for controlling the distortion and aberration characteristics of the optical system 1000. Accordingly, the optical system 1000 may have improved optical performance in the center and peripheral portions of the FOV.

The plurality of lenses may have a set effective diameter (CA: clear aperture). For example, the first lens 110 or the third lens 130 among the first to third lenses 110, 120, and 130 may have the smallest effective diameter. In detail, the first lens 110 or the third lens 130 may have the smallest effective diameter among the first to ninth lenses 110, 120, 130, 140, 150, 160, 170, 180, and 190. The first lens 110 or the third lens 130, which has the smallest effective diameter, may control unnecessary light that may cause vignetting among the light incident to the optical system 1000.

The third lens 130 may have the largest refractive index and the smallest Abbe number among the first to third lenses 110, 120, and 130. Accordingly, the optical system 1000 may have improved chromatic aberration control characteristics.

The fourth to ninth lenses 140, 150, 160, 170, 180, and 190 may have a set refractive index. In detail, the sixth lens 160 may have the highest refractive index among the fourth to ninth lenses 140, 150, 160, 170, 180, and 190. In addition, the sixth lens 160 may have the smallest Abbe number among the fourth to ninth lenses 140, 150, 160, 170, 180, and 190, and may have a difference of 15 or more from the Abbe numbers of each of the fifth lens 150 and the seventh lens 170 disposed adjacent to each other. Accordingly, the optical system 1000 may have improved aberration control characteristics.

The thickness of the seventh lens 170 may be thicker than the thickness of the ninth lens 190. In detail, the thickness of the seventh lens 170 may be the thickest among the plurality of lenses 100. Here, the thickness of the lens means the center thickness and the thickness in the optical axis OA. Accordingly, the optical system 1000 may have improved distortion control characteristics and aberration characteristics.

The optical system 1000 according to the embodiment may satisfy at least one of the equations described below. Accordingly, the optical system 1000 according to the embodiment may have improved resolution. Additionally, the optical system 1000 may have improved distortion and aberration control characteristics and good optical performance in the center and periphery portions of the FOV. Additionally, the optical system 1000 may have a slimmer and more compact structure.

$$1 < L1\_CT / L3\_CT < 5 \qquad [ Equation 1 ]$$

In Equation 1, L1_CT means the thickness (mm) of the first lens 110 in the optical axis OA, and L3_CT means the thickness (mm) of the third lens 130 in the optical axis OA. When the optical system 1000 according to the embodiment satisfies Equation 1, the optical system 1000 may improve aberration characteristics.

$$1 < L1\_CT / L1\_ET < 2 \qquad [ Equation 2 ]$$

In Equation 2, L1_CT means the thickness (mm) of the first lens 110 in the optical axis OA, and L1_ET means the thickness (mm) in a direction of the optical axis OA at an end of the effective region of the first lens 110. In detail, L1_ET means a distance in a direction of the optical axis OA between the end of the effective region of the object-side surface (first surface S1) of the first lens 110 and an end of the effective region of the sensor-side surface (second surface S2) of the first lens 110. When the optical system 1000 according to the embodiment satisfies Equation 2, the optical system 1000 may have good optical performance by controlling the light ray incident to the optical system 1000.

$$0.1 < L7\_ET / L7\_CT < 1 \qquad [ Equation 3 ]$$

In Equation 3, L7_CT means the thickness (mm) of the seventh lens 170 in the optical axis OA, and L7_ET means the thickness (mm) in a direction of the optical axis OA at the end of the effective region of the seventh lens 170. In detail, L7_ET means a distance in a direction of the optical axis OA between the end of the effective region of the object-side surface (thirteenth surface S13) of the seventh lens 170 and an end of the effective region of the sensor-side surface (fourteenth surface S14) of the seventh lens 170. When the optical system 1000 according to the embodiment satisfies Equation 3, the optical system 1000 may reduce distortion and have improved optical performance.

$$0.2 < L8\_CT / L8\_ET < 1 \qquad [ Equation 4 ]$$

In Equation 4, L8_CT means the thickness (mm) of the eighth lens 180 in the optical axis OA, and L8_ET means the thickness (mm) in a direction of the optical axis OA at the end of the effective region of the eighth lens 180. In detail, L8_ET means a distance in a direction of the optical axis OA between an end of the effective region of the object-side surface (fifteenth surface S15) of the eighth lens 180 and an end of the effective region of the sensor-side surface (sixteenth surface S16) of the eighth lens 180. When the optical system 1000 according to the embodiment satisfies Equation 4, the optical system 1000 may reduce distortion and improve optical performance in the peripheral portions of the FOV.

$$1 < L9\_ET / L9\_CT < 4 \qquad [ Equation 5 ]$$

In Equation 5, L9_CT means the thickness (mm) of the ninth lens 190 in the optical axis OA, and L9_ET means the thickness (mm) in a direction of the optical axis OA at the end of the effective region of the ninth lens 190. In detail, L9_ET means in a direction of the optical axis OA between an end of the effective region of the object-side surface (seventeenth surface S17) of the ninth lens 190 and an end of the effective region of the sensor-side surface (eighteenth surface S18) of the ninth lens 190. When the optical system 1000 according to the embodiment satisfies Equation 5, the optical system 1000 may reduce distortion and improve optical performance in the peripheral portion of the FOV.

$$1.6 < n 3 \qquad [ Equation 6 ]$$

In Equation 6, n3 means the refractive index at the d-line of the third lens 130. When the optical system 1000 according to the embodiment satisfies Equation 6, the optical system 1000 may have improved chromatic aberration characteristics.

$$1 < CA\_LlS1 / CA\_L2S1 < 2 \qquad [ Equation 7 ]$$

In Equation 7, CA_LIS1 means a size (mm) of the effective diameter (CA: clear aperture) of the object-side surface (first surface S1) of the first lens 110, and CA_L2S1 means a size (mm) of an effective diameter (CA) of the object-side surface (third surface S3) of the second lens 130. When the optical system 1000 according to the embodiment satisfies Equation 7, the optical system 1000 may have good optical performance by controlling the light ray incident in the optical system 1000, and the aberration characteristics of the optical system 1000 may be improved.

$$1 < CA\_L9S2 / CA\_L2S2 > 5 \qquad [ Equation 8 ]$$

In Equation 8, CA_L2S2 means a size (mm) of an effective diameter (CA) of the sensor-side surface (fourth surface (S4)) of the second lens 120, and CA_L9S2 means a size (mm) of the effective diameter (CA) of the sensor-side surface (eighteenth surface S18) of the ninth lens 190. When the optical system 1000 according to the embodiment satisfies Equation 8, the optical system 1000 may improve aberration characteristics and control distortion characteristics.

$$0.1 < d23\_CT / d23\_ET < 1 \qquad [ Equation 9 ]$$

In Equation 9, d23_CT means the distance (mm) between the second lens 120 and the third lens 130 in the optical axis OA. In detail, d23_CT means a distance (mm) in the optical axis OA between the sensor-side surface (fourth surface S4) of the second lens 120 and the object-side surface (fifth surface S5) of the third lens 130. d23_ET means a distance (mm) in a direction of the optical axis OA between the end of the effective region of the sensor-side surface (fourth side S4) of the second lens 120 and the end of the effective region of the object-side surface (fifth surface S5) of the third lens 130. When the optical system 1000 according to the embodiment satisfies Equation 9, the optical system 1000 may improve chromatic aberration characteristics.

0.3<L9S2 Inflection point<0.8 [Equation 10]

In Equation 10, L9S2 Inflection point may mean a position of the inflection point located in the sensor-side surface (eighteenth surface S18) of the ninth lens 190. In detail, the L9S2 inflection point may mean a position of the inflection point (third inflection point) located in the eighteenth surface S18 when the optical axis OA is a start point, the end point of the effective region of the ninth lens 190 is the end point, and the length in the vertical direction of the optical axis OA from the optical axis OA to the end of the effective region of the eighteenth surface S18 is 1. When the optical system 1000 according to the embodiment satisfies Equation 10, the optical system 1000 may improve distortion characteristics.

$$0.5 < L1\_CT / L2\_CT < 0.78 \qquad [ Equation 11 ]$$

In Equation 11, L1_CT means the thickness (mm) of the first lens 110 in the optical axis OA, and L2_CT means the thickness (mm) of the second lens 120 in the optical axis OA. When the optical system 1000 according to the embodiment satisfies Equation 11, the optical system 1000 may have good optical performance by controlling the light ray incident in the optical system 1000.

$$1. 4 < L7\_CT / L8\_CT < 3.5 \qquad [ Equation 12 ]$$

In Equation 12, L7_CT means a thickness (mm) of the seventh lens 170 in the optical axis OA, and L8_CT means a thickness (mm) of the eighth lens 180 in the optical axis OA. When the optical system 1000 according to the embodiment satisfies Equation 12, the optical system 1000 may improve the aberration characteristics of the peripheral portion of the FOV.

$$1 < L7\_CT / L9\_CT < 3 \qquad [ Equation 13 ]$$

In Equation 13, L7_CT means a thickness (mm) of the seventh lens 170 in the optical axis OA, and L9_CT means a thickness (mm) of the ninth lens 190 in the optical axis OA. When the optical system 1000 according to the embodiment satisfies Equation 13, the optical system 1000 controls the size of the seventh lens 170 and may have good optical performance in the center and periphery portions of the FOV.

$$1 < L1\_CT / d12\_CT < 5 \qquad [ Equation 14 ]$$

In Equation 14, L1_CT means a thickness (mm) of the first lens 110 in the optical axis OA, and d12_CT means a distance (mm) between the first lens 110 and the second lens 120 in the optical axis OA. In detail, d12_CT means a distance (mm) between the sensor-side surface (second surface S2) of the first lens 110 and the object-side surface (third surface S3) of the second lens 120 in the optical axis OA. When the optical system 1000 according to the embodiment satisfies Equation 14, the optical system 1000 may have good optical performance by controlling the light ray incident in the optical system 1000.

$$1 < L2\_CT / d12\_CT < 7 \qquad [ Equation 15 ]$$

In Equation 15, L2_CT means the thickness (mm) of the second lens 120 in the optical axis OA, and d12_CT means a distance (mm) between the first lens 110 and the second lens 120 in the optical axis OA. In detail, d12_CT means a distance (mm) between the sensor-side surface (second surface S2) of the first lens 110 and the object-side surface (third surface S3) of the second lens 120 in the optical axis OA. When the optical system 1000 according to the embodiment satisfies Equation 15, the optical system 1000 may have good optical performance by controlling the light ray incident in the optical system 1000.

$$1 < L4\_CT / d45\_CT < 2.5 \qquad [ Equation 16 ]$$

In Equation 16, L4_CT means a thickness (mm) of the fourth lens 140 in the optical axis OA, and d45_CT means a distance (mm) between the fourth lens 140 and the fifth lens 150 in the optical axis OA. In detail, d45_CT means a distance (mm) between the sensor-side surface (eighth surface S8) of the fourth lens 140 and the object-side surface (ninth surface S9) of the fifth lens 150 in the optical axis. When the optical system 1000 according to the embodiment satisfies Equation 16, the optical system 1000 may improve aberration characteristics.

$$0.2 < d12\_CT / d89\_CT < 1 \qquad [ Equation 17 ]$$

In Equation 17, d12_CT means a distance (mm) between the first lens 110 and the second lens 120 in the optical axis OA. In detail, d12_CT means a distance (mm) between the sensor-side surface (second surface S2) of the first lens 110 and the object-side surface (third surface S3) of the second lens 120 in the optical axis OA. d89_CT means a distance (mm) between the eighth lens 180 and the ninth lens 190 in the optical axis OA. In detail, d89_CT means a distance (mm) between the sensor-side surface (sixteenth surface S16) of the eighth lens 180 and the object-side surface (seventeenth surface S17) of the ninth lens 190 in the optical axis OA. When the optical system 1000 satisfies Equation 17, the optical system 1000 has a slim and compact structure and may have good optical performance at a set FOV.

$$0.85 < L1\_CT / L9\_CT < 1.8 \qquad [ Equation 18 ]$$

In Equation 18, L1_CT means the thickness (mm) of the first lens 110 in the optical axis OA, and L9_CT means the thickness (mm) of the ninth lens 190 in the optical axis OA. When the optical system 1000 satisfies Equation 18, the optical system 1000 has a slim and compact structure and may have good optical performance at a set FOV.

$$5 < L7\_CT / d78\_CT < 16 \qquad [ Equation 19 ]$$

In Equation 19, L7_CT means the thickness (mm) of the seventh lens 170 in the optical axis OA, and d78_CT means a distance (mm) between the seventh lens 170 and the eighth lens 180 in the optical axis OA. In detail, d78_CT means a distance (mm) between the sensor-side surface (fourteenth surface S14) of the seventh lens 170 and the object-side surface (fifteenth surface S15) of the eighth lens 180 in the optical axis OA. When the optical system 1000 according to the embodiment satisfies Equation 19, the optical system 1000 may reduce the size of the effective diameter of the seventh lens 170, and may reduce the distance between the seventh lens 170 and the eighth lens 180 in the optical axis OA, thereby having good optical performance at the peripheral portion of the FOV.

$$2.2 < L7\_CT / d67\_CT < 10 \qquad [ Equation 20 ]$$

In Equation 20, L7_CT means the thickness (mm) of the seventh lens 170 in the optical axis OA, and d67_CT means the distance (mm) between the sixth lens 160 and the seventh lens 170 in the optical axis OA. In detail, d67_CT means a distance (mm) between the sensor-side surface (twelfth surface S12) of the sixth lens 160 and the object-side surface (thirteenth surface S13) of the seventh lens 170 in the optical axis. When the optical system 1000 satisfies Equation 20, the optical system 1000 may be provided slimmer by reducing the size of the effective diameter of the seventh lens 170.

$$7 < f 1 / f 2 < 13.5 \qquad [ Equation 21 ]$$

In Equation 21, f1 means the focal length (mm) of the first lens 110, and f2 means the focal length (mm) of the second lens 120. When the optical system 1000 according to the embodiment satisfies Equation 21, the optical system 1000 may have good optical performance by controlling the refractive power of the first lens 110 and the second lens 120.

$$- 2 < f 3 / f 2 < - 0.5 \qquad [ Equation 22 ]$$

In Equation 22, f2 means the focal length (mm) of the second lens 120, and f3 means the focal length (mm) of the third lens 130. When the optical system 1000 according to the embodiment satisfies Equation 22, the optical system 1000 may have good optical performance by controlling the refractive power of the second lens 120 and the third lens 130.

$$- 1 < f 7 / f 8 < - 0.4 \qquad [ Equation 23 ]$$

In Equation 23, f7 means the focal length (mm) of the seventh lens 170, and f8 means the focal length (mm) of the eighth lens 180. When the optical system 1000 according to the embodiment satisfies Equation 23, the optical system 1000 may have good optical performance by controlling the refractive power of the seventh lens 170 and the eighth lens 180.

$$5 < f\_G1 / F < 12 \qquad [ Equation 24 ]$$

In Equation 24, F means the focal length (mm) of the optical system 1000, and f_G1 means the focal length (mm) of the first lens group G1. In an embodiment, the sensor-side surface (second surface S2) of the first lens 110 may function as an aperture stop. Accordingly, f_G1 means the focal length of the first lens 110 included in the first lens group G1. When the optical system 1000 according to the embodiment satisfies Equation 24, the optical system 1000 may control the total track length (TTL) of the optical system 1000.

$$f\_G1 > 0 and f\_G2 > 0 \qquad [ Equation 25 ]$$

In Equation 25, f_G1 means the focal length (mm) of the first lens group G1, and f_G2 means the focal length (mm) of the second lens group G2. In an embodiment, the sensor-side surface (second surface S2) of the first lens 110 may function as an aperture stop. Accordingly, f_G1 may mean the focal length of the first lens 110 included in the first lens group G1, and f_G2 may mean the composite focal length of the second to ninth lenses 120, 130, 140, 150, 160, 170, 180, and 190 included in the second lens group G2. When the optical system 1000 according to the embodiment satisfies Equation 25, the optical system 1000 may have improved distortion aberration control characteristics.

$$5 < f\_G1 / f\_G2 < 20 \qquad [ Equation 26 ]$$

In Equation 26, f_G1 means the focal length (mm) of the first lens group G1, and f_G2 means the focal length (mm) of the second lens group G2. In an embodiment, the sensor-side surface (second surface S2) of the first lens 110 may function as an aperture stop. Accordingly, f_G1 may mean the focal length of the first lens 110 included in the first lens group G1, and f_G2 may mean the composite focal length of the second to ninth lenses 120, 130, 140, 150, 160, 170, 180, and 190 included in the second lens group G2. When the optical system 1000 satisfies Equation 26, the optical system 1000 may have improved distortion aberration control characteristics.

$$1 < CA\_max / CA\_Aver < 2.5 \qquad [ Equation 27 ]$$

In Equation 27, CA_max means the effective diameter (CA, mm) of the lens surface having the largest effective diameter (CA) among the object-side and sensor-side surfaces of the plurality of lenses 100. In addition, CA_Aver means an average of the effective diameters (CA, mm) of the object-side surfaces and the sensor-side surfaces of the plurality of lenses 100. When the optical system 1000 satisfies Equation 27, the optical system 1000 may be provided in a slim and compact structure and have an appropriate size for realizing optical performance.

$$0.5 < CA\_min / CA\_Aver < 1 \qquad [ Equation 28 ]$$

In Equation 28, CA_min means the effective diameter (CA, mm) of the lens surface having the smallest effective diameter (CA) among the object-side surfaces and sensor-side surfaces of the plurality of lenses 100. In addition, CA_Aver means the average of the effective diameters (CA, mm) of the object-side surfaces and the sensor-side surfaces of the plurality of lenses 100. When the optical system 1000 satisfies Equation 28, the optical system 1000 may be provided in a slim and compact structure and have an appropriate size for realizing optical performance.

$$1.5 < CA\_max / CA\_min < 3 \qquad [ Equation 29 ]$$

In Equation 29, CA_max means the effective diameter (CA, mm) of the lens surface having the largest effective diameter (CA) among the object-side and sensor-side surfaces of the plurality of lenses 100. In addition, CA_min means the effective diameter (CA, mm) of the lens surface having the smallest effective diameter (CA) among the object-side and sensor-side surfaces of the plurality of lenses 100. When the optical system 1000 according to the embodiment satisfies Equation 29, the optical system 1000 may be provided in a slim and compact structure while maintaining optical performance, and may have improved assembly properties.

$$1 < L\_CT \_max / L\_CT \_Aver < 2.5 \qquad [ Equation 30 ]$$

In Equation 30, L_CT_max means the thickness (mm) in the optical axis OA of the lens with the thickest thickness in the optical axis OA among the plurality of lenses 100, and L_CT_Aver means an average of the thicknesses (mm) of the plurality of lenses 100. When the optical system 1000 satisfies Equation 30, the optical system 1000 has good optical performance at a set FOV and may be provided in a slim and compact structure.

$$0.35 < L\_CT \_min / L\_CT \_Aver < 1 \qquad [ Equation 31 ]$$

In Equation 31, L_CT_min means the thickness (mm) in the optical axis OA of the lens with the thickest thickness in the optical axis OA among the plurality of lenses 100, and L_CT_Aver means an average of the thicknesses (mm) of the plurality of lenses 100 in the optical axis OA. When the optical system 1000 according to the embodiment satisfies Equation 31, the optical system 1000 has good optical performance at a set FOV and may be provided in a slim and compact structure.

$$0.5 < CA\_max / ( 2 * ImgH ) < 1 \qquad [ Equation 32 ]$$

In Equation 32, CA_max means the effective diameter (CA, mm) of the lens surface having the largest effective diameter (CA) among the object-side and sensor-side surfaces of the plurality of lenses 100. ImgH means the distance (mm) in a vertical direction with respect to the optical axis OA from the center filed (0 field) in the image surface of the image sensor 300 overlapping the optical axis OA to the 1.0 filed of the image sensor 300. That is, ImgH means ½ of the maximum diagonal length (mm) of the effective region of the image sensor 300. When the optical system 1000 according to the embodiment satisfies Equation 32, the optical system 1000 may be provided in a slim and compact structure.

$$1 < d 89 \_CT / d89\_min < 20 \qquad [ Equation 33 ]$$

In Equation 33, d89_CT means a distance (mm) between the eighth lens 180 and the ninth lens 190 in the optical axis OA. In detail, d89_CT means a distance (mm) between the sensor-side surface (sixteenth surface S16) of the eighth lens 180 and the object-side surface (seventeenth surface S17) of the ninth lens 190 in the optical axis OA. d89_min means the minimum distance (mm) in the direction of the optical axis OA between the sensor-side surface (sixteenth surface S16) of the eighth lens 180 and the object-side surface (seventeenth surface S17) of the ninth lens 190. When the optical system 1000 according to the embodiment satisfies Equation 33, the optical system 1000 may improve distortion aberration characteristics and have good optical performance in the peripheral portion of the FOV.

$$0 < L\_CT \_max / Air\_max < 3 \qquad [ Equation 34 ]$$

In Equation 34, L_CT_max means the thickness (mm) in the optical axis OA of the thickest lens among the thicknesses in the optical axis OA of each of the plurality of lenses 100, and Air_max means a maximum value (mm) of the distances between two adjacent lenses of the plurality of lenses 100 in the optical axis OA. When the optical system 1000 according to the embodiment satisfies Equation 34, the optical system 1000 has good optical performance at a set FOV and focal length, and may control the size of the optical system 1000, for example, reducing TTL.

$$1 < \sum L\_CT / \sum Air\_CT < 5 \qquad [ Equation 35 ]$$

In Equation 27, ΣL_CT means a sum of the thicknesses (mm) of each of the plurality of lenses 100 in the optical axis OA, and ΣAir_CT means a sum of the distances (mm) between two adjacent lenses in the plurality of lenses 100 in the optical axis OA. When the optical system 1000 according to the embodiment satisfies Equation 35, the optical system 1000 has good optical performance at a set FOV and focal length, and may control the size of the optical system 1000, for example, reducing TTL.

$$10 < \sum Index < 30 \qquad [ Equation 36 ]$$

In Equation 36, ΣIndex means a sum of the refractive indices in the d-line of each of the first to ninth lenses 110, 120, 130, 140, 150, 160, 170, 180, and 190. When the optical system 1000 according to the embodiment satisfies Equation 36, the optical system 1000 may control TTL and may have improved chromatic aberration and resolution characteristics.

$$10 < \sum Abbe / \sum Index < 50 \qquad [ Equation 37 ]$$

In Equation 37, ΣIndex means a sum of the refractive indices at the d-line of each of the first to ninth lenses 110, 120, 130, 140, 150, 160, 170, 180, and 190. Additionally, 2Abbe means the sum of Abbe numbers of each of the first to ninth lenses 110, 120, 130, 140, 150, 160, 170, 180, and 190. When the optical system 1000 according to the embodiment satisfies Equation 37, the optical system 1000 may have improved aberration characteristics and resolution.

$$0.5 < L9S2\_max \_sag to Sensor < 2 \qquad [ Equation 38 ]$$

In Equation 38, L9S2_max_sag to Sensor means a distance (mm) in the optical axis OA direction from the maximum Sag value in the sensor-side surface (eighteenth side S18) of the ninth lens 190 to the image sensor 300. For example, L9S2_max_sag to Sensor means the distance (mm) in the optical axis OA direction from the third inflection point to the image sensor 300. When the optical system 1000 according to the embodiment satisfies Equation 38, the optical system 1000 secures a space where the filter 500 may be placed between the plurality of lenses 100 and the image sensor 300, thereby having improved assembling. Additionally, when the optical system 1000 satisfies Equation 38, the optical system 1000 may secure a distance for module manufacturing.

In the lens data for the embodiment to be described later, the position of the filter, in detail, the distance between the last lens (the ninth lens 190) and the filter 500, and the distance between the image sensor 300 and the filter 500 are positions set for convenience in the design of the optical system 1000, and the filter 500 may be freely disposed within a range of not contacting the two components (190 and 300), respectively. Accordingly, when the value of L9S2_max_sag to Sensor in the lens data is less than or equal to the distance in the optical axis OA between the object-side surface of the filter 500 and an image surface of the image sensor 300, BFL and L9S2_max_sag to Sensor of the optical system 1000 do not change and are constant, and the position of the filter 500 moves within a range that does not contact the two components (190 and 300), respectively, so that good optical performance may be achieved.

$$2 < TTL < 20 \qquad [ Equation 39 ]$$

In Equation 39, TTL (Total track length) is a distance (mm) in the optical axis OA from the vertex of the object-side surface (first surface S1) of the first lens 110 to the image surface of the image sensor 300.

$$2 < ImgH \qquad [ Equation 40 ]$$

In Equation 40, ImgH means the distance (mm) in a vertical direction with respect to the optical axis OA from the center filed (0 field) in the image surface of the image sensor 300 overlapping the optical axis OA to the 1.0 filed of the image sensor 300. That is, ImgH means ½ of the maximum diagonal length (mm) of the effective region of the image sensor 300.

$$BFL < 2.5 \qquad [ Equation 41 ]$$

In Equation 41, BFL (Back focal length) means a distance (mm) in the optical axis OA from the vertex of the sensor-side surfaces of the lens closest to the image sensor 300 to the image surface of the image sensor 300. When the optical system 1000 according to the embodiment satisfies Equation 41, the optical system 1000 may secure a space in which a configuration such as the filter 500 or the like is disposed between the plurality of lenses 100 and the image sensor 300, thereby having improved assemblability. Accordingly, the optical system 1000 may transmit light in a set wavelength band and have improved reliability.

$$FOV < 120 \qquad [ Equation 42 ]$$

In Equation 42, FOV (Field of view) means an angle (degrees, °) of view of the optical system 1000.

$$0.5 < TTL / ImgH < 2 \qquad [ Equation 43 ]$$

In Equation 43, TTL is a distance (mm) in the optical axis OA from the vertex of the object-side surface (first surface S1) of the first lens 110 to the image surface of the image sensor 300. ImgH means the distance (mm) in a vertical direction with respect to the optical axis OA from the center filed (0 field) in the image surface of the image sensor 300 overlapping the optical axis OA to the 1.0 filed of the image sensor 300. That is, ImgH means ½ of the maximum diagonal length (mm) of the effective region of the image sensor 300. When the optical system 1000 satisfies Equation 43, the optical system 1000 may have a back focal length (BFL) for application to image sensors 300 having a relatively large size, such as a size around 1 inch, and may have a smaller TTL, a higher resolution implementation, and a slimmer structure.

$$0.1 < BFL / ImgH < 0.5 \qquad [ Equation 44 ]$$

In Equation 44, BFL (Back focal length) means a distance (mm) in the optical axis OA from the vertex of the sensor-side surfaces of the lens closest to the image sensor 300 to the image surface of the image sensor 300. ImgH means the distance (mm) in a vertical direction with respect to the optical axis OA from the center filed (0 field) in the image surface of the image sensor 300 overlapping the optical axis OA to the 1.0 filed of the image sensor 300. That is, ImgH means ½ of the maximum diagonal length (mm) of the effective region of the image sensor 300. When the optical system 1000 according to the embodiment satisfies Equation 44, the optical system 1000 may have a BFL for applying an image sensor 300 having a relatively large size, such as a size around 1 inch, and may minimize the distance between the last lens and the image sensor 300 to have good optical properties in the center and periphery portions of the FOV.

$$4 < TTL / BFL < 10 \qquad [ Equation 45 ]$$

In Equation 45, TTL is a distance (mm) in the optical axis OA from the vertex of the object-side surface (first surface S1) of the first lens 110 to the image surface of the image sensor 300. In addition, back focal length (BFL) means the distance (mm) in the optical axis OA from the vertex of the sensor-side surface of the lens closest to the image sensor 300 to the image surface of the image sensor 300. When the optical system 1000 according to the embodiment satisfies Equation 45, the optical system 1000 secures BFL and may be provided in a slim and compact size.

$$0.1 < F / TTL < 1 \qquad [ Equation 46 ]$$

In Equation 40, F means the total focal length (mm) of the optical system 1000, and TTL is a distance (mm) in the optical axis OA from the vertex of the object-side surface (first surface S1) of the first lens 110 to the image surface of the image sensor 300. When the optical system 1000 according to the embodiment satisfies Equation 46, the optical system 1000 may be provided in a slim and compact size.

$$3 < F / BFL < 8 \qquad [ Equation 47 ]$$

In Equation 47, F means the total focal length (mm) of the optical system 1000, and BFL (Back focal length) means the distance (mm) in the optical axis OA from the vertex of the sensor-side surface of the lens closest to the image sensor 300 to the image surface of the image sensor 300. When the optical system 1000 according to the embodiment satisfies Equation 47, the optical system 1000 has a set FOV and may be provided in a slim and compact size. Additionally, the optical system 1000 may minimize the distance between the last lens and the image sensor 300 and thus have good optical characteristics in the peripheral portion of the FOV.

$$1 < F / ImgH < 3 \qquad [ Equation 48 ]$$

In Equation 48, F means the total focal length (mm) of the optical system 1000, and ImgH means the distance (mm) in a vertical direction with respect to the optical axis OA from the center filed (0 field) in the image surface of the image sensor 300 overlapping the optical axis OA to the 1.0 filed of the image sensor 300. That is, ImgH means ½ of the maximum diagonal length (mm) of the effective region of the image sensor 300. When the optical system 1000 according to the embodiment satisfies Equation 48, the optical system 1000 has an appropriate focal length compared to the size of the image sensor 300, may have improved aberration control characteristics, and may implement high image quality and high resolution.

$$[ Equation 49 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} +$$

In Equation 49, Z is Sag and may mean a distance in the optical axis direction from any position on the aspherical surface to the vertex of the aspherical surface. Y may mean a distance from any location on the aspherical surface to the optical axis in a direction perpendicular to the optical axis. c may mean the curvature of the lens, and K may mean a Conic constant. A, B, C, D, E, and F may mean aspheric coefficient.

The optical system 1000 according to the embodiment may satisfy at least one of Equations 1 to 48. In this case, the optical system 1000 may have improved optical characteristics. In detail, when the optical system 1000 satisfies at least one of Equations 1 to 48, the optical system 1000 has improved resolution and may improve aberration and distortion characteristics. The optical system 1000 may secure a BFL for application to a relatively large image sensor 300, for example, around 1 inch. Additionally, the distance between lenses and/or between the last lens and the image sensor 300 may be minimized, allowing good optical performance in the center and periphery portions of the FOV. When the optical system 1000 satisfies at least one of Equations 1 to 48, the optical system includes a relatively large image sensor 300, for example, an image sensor 300 around 1 inch and may have a relatively small TTL value, and the optical system 1000 and a camera module including the same may have a slimmer compact structure.

In the optical system 1000 according to an embodiment, the distances between the plurality of lenses 100 may have a value set according to the regions. The first lens 110 may be spaced apart from the second lens 120 by a first distance. The first distance may be a distance in the optical axis OA direction between the first lens 110 and the second lens 120. The first distance may vary depending on the position between the first lens 110 and the second lens 120. In detail, the first distance may change from the optical axis OA toward the vertical direction of the optical axis OA when the optical axis OA is a starting point and the end of the effective region of the sensor-side surface (second surface S2) of the first lens 110 is an end point. That is, the first distance may change from the optical axis OA to an end of the effective diameter of the second surface S2. The first distance may become smaller as it moves from the optical axis OA to the first point CP1 located on the second surface S2. The first point CP1 may be disposed at a position that is about 40% to about 95% of the effective radius of the second surface S2 based on the optical axis OA.

The first distance may increase from the first point CP1 in a direction perpendicular to the optical axis OA. For example, the first distance may increase from the first point CP1 to the second point CP2 located on the second surface S2. Here, the second point CP2 may be the end of the effective region of the second surface S2. The first distance may have a maximum value in the optical axis OA or the second point CP2 and a minimum value at the first point CP1. At this time, the maximum value of the first distance may be about 1.03 times or more than the minimum value. In detail, the maximum value of the first distance may satisfy about 1.03 to about 1.5 times the minimum value. Accordingly, the optical system 1000 may effectively control incident light. In detail, as the first lens 110 and the second lens 120 are spaced apart at the first distance, light incident through the first lens 110 and the second lens 120 may move in a set path to have good optical performance.

The fifth lens 150 and the sixth lens 160 may be spaced apart by a second distance. The second distance may be a distance in the optical axis OA direction between the fifth lens 150 and the sixth lens 160. The second distance may vary depending on the position between the fifth lens 150 and the sixth lens 160. In detail, the second distance may change from the optical axis OA toward the vertical direction of the optical axis OA when an end of the effective region of the sensor-side surface (tenth surface S10) of the fifth lens 150 is the end point based on the optical axis OA. That is, the second distance may change from the optical axis OA to the effective diameter end of the tenth surface S10. The second distance may become smaller as it moves from the optical axis OA to the third point CP3 located on the tenth surface S10. Here, the third point CP3 may be the end of the effective region of the tenth surface S10. The second distance may have a maximum value at the optical axis OA and a minimum value at the third point CP3. At this time, the maximum value of the second distance may be about 1.5 times or more than the minimum value. In detail, the maximum value of the second distance may be about 1.5 times to about 3 times the minimum value. Alternatively, the second distance may become smaller as it moves from the optical axis OA to the third point CP3 located on the tenth surface S10. The third point CP3 may be disposed at a position that is about 70% to about 90% of the effective radius of the tenth surface S10 based on the optical axis OA.

The second distance may increase from the third point CP3 in a direction perpendicular to the optical axis OA. For example, the second distance may increase from the third point CP3 to the fourth point CP4 located on the tenth surface S10. Here, the fourth point CP4 may be the end of the effective region of the tenth surface S10. The second distance may have a maximum value at the optical axis OA and a minimum value at the third point CP3. At this time, the maximum value of the second distance may be about 1.5 times or more than the minimum value. In detail, the maximum value of the second distance may satisfy about 1.5 to about 2 times the minimum value. Accordingly, the optical system 1000 may have improved aberration control characteristics and good optical performance in the peripheral portion of the FOV.

The sixth lens 160 and the seventh lens 170 may be spaced apart at a third distance. The third distance may be a distance in the optical axis OA direction between the sixth lens 160 and the seventh lens 170. The third distance may vary depending on the position between the sixth lens 160 and the seventh lens 170. In detail, the third distance may change from the optical axis OA toward the vertical direction of the optical axis OA when the optical axis OA is a starting point and the end of the effective region of the sensor-side surface (twelfth surface S12) of the sixth lens 160 is an end point. That is, the third distance may change from the optical axis OA to an end of the effective diameter of the twelfth surface S12.

The third distance may increase from the optical axis OA to a fifth point CP5 located on the twelfth surface S12. The fifth point CP5 may be disposed at a position that is about 80% to about 95% of the effective radius of the twelfth surface S12 based on the optical axis OA. The third distance may become smaller as it goes from the fifth point CP5 in a direction perpendicular to the optical axis OA. For example, the third distance may become smaller from the fifth point CP5 to the sixth point CP6 located on the twelfth surface S12. Here, the sixth point CP6 may be the end of the effective region of the twelfth surface S12. The third distance may have a maximum value at the fifth point CP5 and a minimum value at the optical axis OA. At this time, the maximum value of the third distance may be about 1.2 times or more than the minimum value. In detail, the maximum value of the third distance may satisfy about 1.2 times to about 2 times the minimum value. Accordingly, the optical system 1000 may have a slim structure by reducing the size of the effective diameter of the seventh lens 170, and the distortion characteristics of the optical system 1000 may be controlled.

The seventh lens 170 and the eighth lens 180 may be spaced apart at a fourth distance. The fourth distance may be a distance in the optical axis OA direction between the seventh lens 170 and the eighth lens 180. The fourth distance may vary depending on the position between the seventh lens 170 and the eighth lens 180. In detail, the fourth distance may change from the optical axis OA toward the vertical direction of the optical axis OA when the optical axis OA is a starting point and the end of the effective region of the sensor-side surface (fourteenth surface S14) of the seventh lens 170 is an end point. That is, the fourth distance may change from the optical axis OA to an end of the effective diameter of the fourteenth surface S14. The fourth distance may increase from the optical axis OA to the seventh point CP7 located on the fourteenth surface S14. The seventh point CP7 may be disposed at a position that is about 60% to about 90% of the effective radius of the fourteenth surface S14 based on the optical axis OA.

The fourth distance may become smaller as it goes from the seventh point CP7 in a direction perpendicular to the optical axis OA. For example, the fourth distance may become smaller from the seventh point CP7 to the eighth point CP8 located on the fourteenth surface S14. Here, the eighth point CP8 may be the end of the effective region of the fourteenth surface S14. The fourth distance may have a maximum value at the seventh point CP7 and a minimum value at the optical axis OA. At this time, the maximum value of the fourth distance may be about 2.5 times or more than the minimum value. In detail, the maximum value of the fourth distance may satisfy about 2.5 to about 4.5 times the minimum value.

Alternatively, the fourth distance may increase from the optical axis OA toward the seventh point CP7 located on the fourteenth surface S14. The seventh point CP7 may be disposed at a position about 50% to about 70% based on the direction perpendicular to the optical axis OA, when the optical axis OA is the starting point and the end point of the effective region of the fourteenth surface S14 is the end point.

The fourth distance may become smaller as it goes from the seventh point CP7 in a direction perpendicular to the optical axis OA. For example, the fourth distance may become smaller from the seventh point CP7 to the eighth point CP8 located on the fourteenth surface S14. The eighth point CP8 may be located at a greater distance from the optical axis OA than the seventh point CP7. The eighth point CP8 may be disposed at a position that is about 80% to about 95% of the effective radius of the fourteenth surface S14 with respect to the optical axis OA. The fourth distance may increase from the eighth point CP8 in a direction perpendicular to the optical axis OA. For example, the fourth distance may increase from the eighth point CP8 to the ninth point CP9 located on the fourteenth surface S14. Here, the ninth point CP9 may be the end of the effective region of the fourteenth surface S14.

The fourth distance may have a maximum value at the seventh point CP7 and a minimum value at the optical axis OA. At this time, the maximum value of the fourth distance may be about 2.5 times or more than the minimum value. In detail, the maximum value of the fourth distance may satisfy about 2.5 to about 4.5 times the minimum value. Accordingly, the optical system 1000 may control the distortion characteristics of the optical system 1000 and have good optical performance in the center and periphery portions of the FOV.

The eighth lens 180 and the ninth lens 190 may be spaced apart at a fifth distance. The fifth distance may be a distance in the optical axis OA direction between the eighth lens 180 and the ninth lens 190. The fifth distance may vary depending on the position between the eighth lens 180 and the ninth lens 190. In detail, the fifth distance may change from the optical axis OA to the vertical direction of the optical axis OA when the optical axis OA is a starting point and the end of the effective region of the sensor-side surface (sixteenth surface S16) of the eighth lens 180. That is, the fifth distance may change from the optical axis OA toward an end of the effective diameter of the sixteenth surface S16. The fifth distance may become smaller as it moves from the optical axis OA to the tenth point CP10 located on the sixteenth surface S16. The tenth point CP10 may be disposed at a position that is about 70% to about 90% of the effective radius of the sixteenth surface S16 based on the optical axis OA.

The fifth distance may increase from the tenth point CP10 in a direction perpendicular to the optical axis OA. For example, the fifth distance may increase from the tenth point CP10 to the eleventh point CP11 located on the sixteenth surface S16. Here, the eleventh point CP11 may be the end of the effective region of the sixteenth surface S16. The fifth distance may have a maximum value at the optical axis OA and a minimum value at the tenth point CP10. At this time, the maximum value of the fifth distance may be about 10 times or more than the minimum value. In detail, the maximum value of the fifth distance may satisfy about 10 to about 20 times the minimum value. Accordingly, the optical system 1000 may have improved chromatic aberration and distortion aberration control characteristics, and may have good optical performance in the center and periphery portions of the FOV.

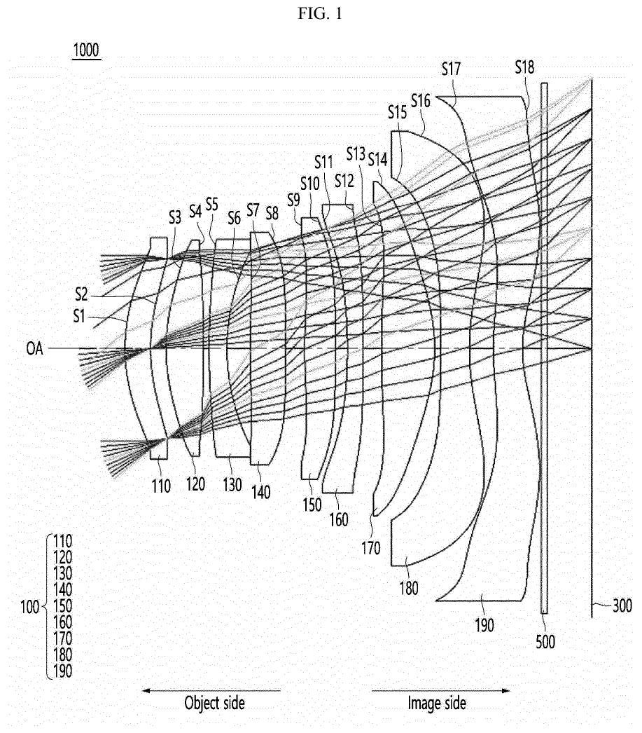

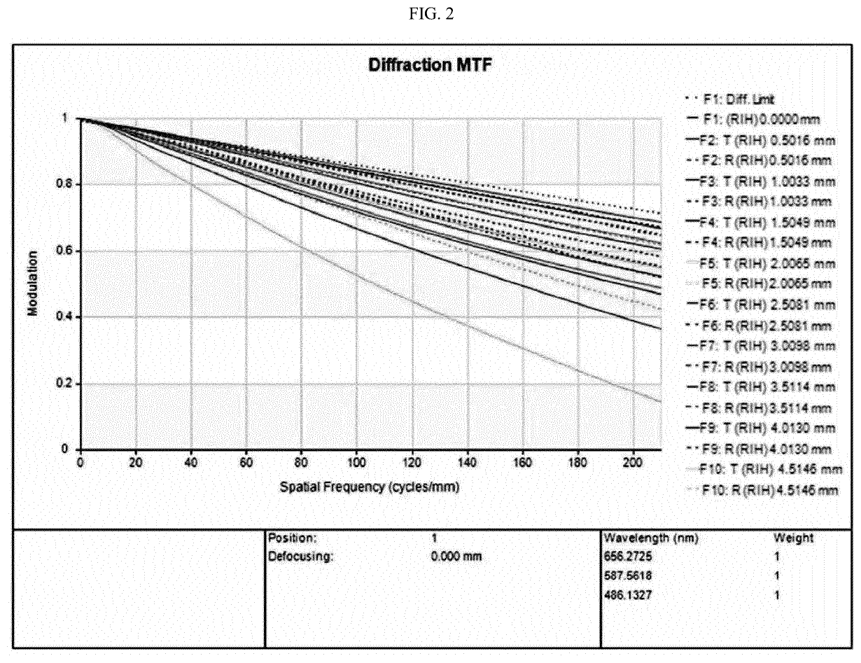

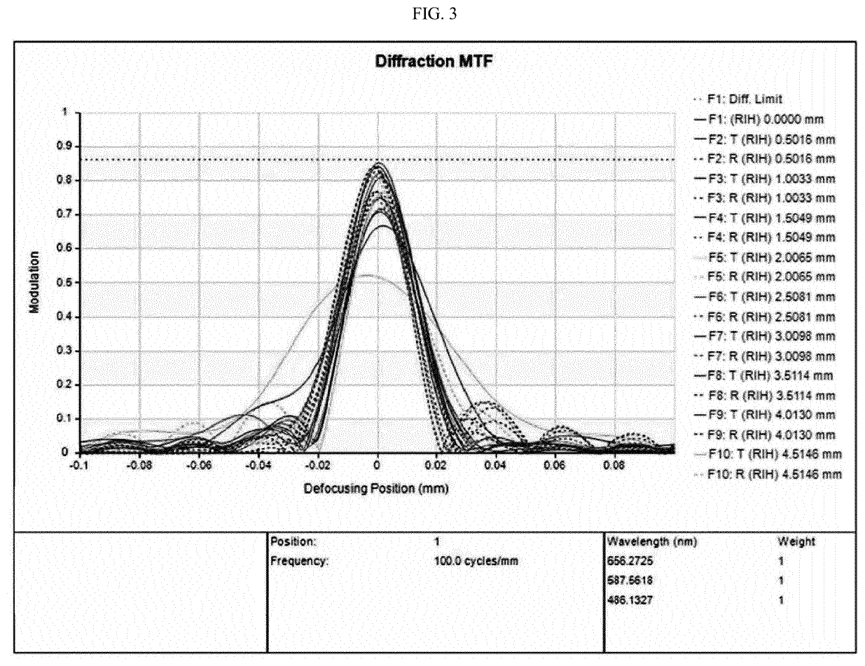

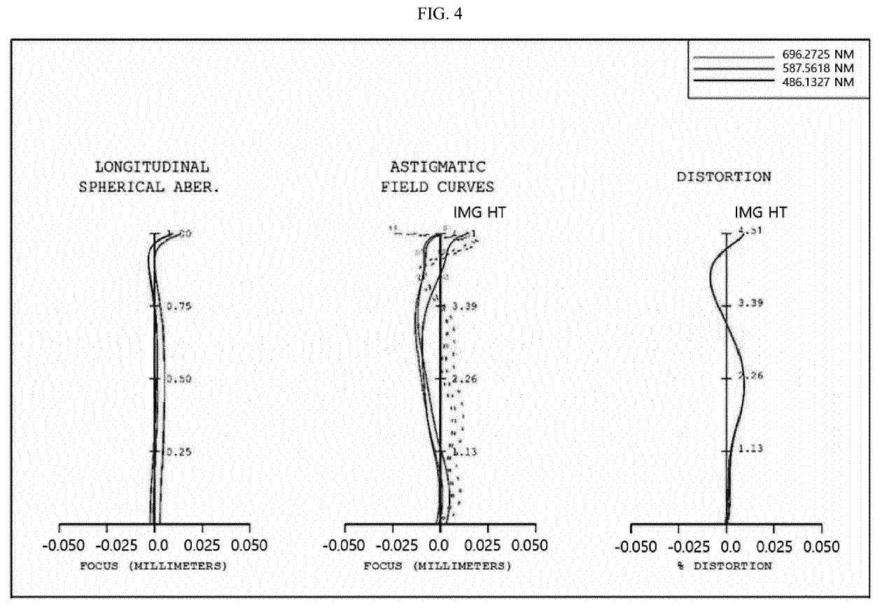

The optical system 1000 according to the first embodiment will be described in more detail with reference to the drawings below. FIG. 1 is a configuration diagram of an optical system according to a first embodiment. In addition, FIG. 2 is a graph of the MTF against spatial frequency of the optical system according to the first embodiment, FIG. 3 is a graph of the diffraction MTF of the optical system according to the first embodiment, and FIG. 4 is an aberration graph of the optical system according to the first embodiment.

Referring to FIGS. 1 to 3, the optical system 1000 according to the first embodiment includes a first lens 110, a second lens 120, a third lens 130, a fourth lens 140, a fifth lens 150, a sixth lens 160, a seventh lens 170, an eighth lens 180, a ninth lens 190, and an image sensor 300. The first to ninth lenses 110, 120, 130, 140, 150, 160, 170, 180, and 190 may be sequentially arranged along the optical axis OA of the optical system 1000. In the optical system 1000 according to the first embodiment, an aperture stop may be disposed between the first lens 110 and the second lens 120. The sensor-side surface (second surface S2) of the first lens 110 may function as an aperture stop. A filter 500 may be disposed between the plurality of lenses 100 and the image sensor 300. In detail, the filter 500 may be disposed between the ninth lens 190 and the image sensor 300.

TABLE 1

| | | Radius of | Thickness (mm)/ | Reflective | Abbe | Effective |
|---|---|---|---|---|---|---|
| Lens | Surface | curvature (mm) | Distance (mm) | Index | number | diameter (mm) |
| Lens 1 | S1 | 2.881 | 0.435 | 1.529 | 62.48 | 3.155 |
| | S2 | 3.020 | 0.265 | | | 3.000 |
| | (Stop) | | | | | |
| Lens 2 | S3 | 3.187 | 0.631 | 1.627 | 59.09 | 3.094 |
| | S4 | −50.277 | 0.100 | | | 3.132 |
| Lens 3 | S5 | 10.988 | 0.305 | 1.755 | 57.57 | 3.167 |
| | S6 | 3.378 | 0.398 | | | 3.156 |
| Lens 4 | S7 | 17.389 | 0.597 | 1.734 | 45.62 | 3.185 |
| | S8 | 120.657 | 0.328 | | | 3.464 |
| Lens 5 | S9 | 9.780 | 0.524 | 1.744 | 44.85 | 3.742 |
| | S10 | −107.295 | 0.205 | | | 3.930 |
| Lens 6 | S11 | −7.951 | 0.260 | 1.755 | 27.57 | 4.000 |
| | S12 | 95.604 | 0.321 | | | 4.389 |
| Lens 7 | S13 | 18.227 | 0.906 | 1.682 | 50.82 | 4.850 |
| | S14 | −2.691 | 0.100 | | | 5.183 |
| Lens 8 | S15 | −42.420 | 0.489 | 1.512 | 58.38 | 5.460 |
| | S16 | 4.018 | 0.409 | | | 6.606 |
| Lens 9 | S17 | 4.942 | 0.495 | 1.746 | 40.17 | 6.907 |
| | S18 | 2.199 | 0.320 | | | 7.655 |
| Filter | | Infinity | 0.110 | | | 7.971 |
| | | Infinity | 0.749 | | | 8.056 |
| Image | | Infinity | 0.001 | | | 9.029 |
| sensor | | | | | | |

Table 1 shows the radius of curvature on the optical axis OA of the first to ninth lenses 110, 120, 130, 140, 140, 150, 160, 170, 180, and 190 according to a first embodiment, the thickness of the lens, the distance between the lenses, the refractive index, Abbe Number, and the size of the effective diameter (CA: clear aperture). The first lens 110 of the optical system 1000 according to the first embodiment may have positive (+) refractive power on the optical axis OA. The first surface S1 of the first lens 110 may have a convex shape on the optical axis OA, and the second surface S2 may have a concave shape on the optical axis OA. The first lens 110 may have a meniscus shape that is convex on the optical axis OA toward the object. The first surface S1 and the second surface S2 may have aspheric coefficients as shown in Table 2 below. The second lens 120 may have positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspheric coefficients as shown in Table 2 below.

The third lens 130 may have negative refractive power on the optical axis OA. The fifth surface S5 of the third lens 130 may have a convex shape on the optical axis OA, and the sixth surface S6 may have a concave shape on the optical axis OA. The third lens 130 may have a meniscus shape that is convex on the optical axis OA toward the object. The fifth surface S5 may be an aspherical surface, and the sixth surface S6 may be an aspherical surface. The fifth surface S5 and the sixth surface S6 may have aspherical coefficients as shown in Table 2 below. The fourth lens 140 may have positive (+) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape that is convex on the optical axis OA toward the object. The seventh surface S7 may be an aspherical surface, and the eighth surface S8 may be an aspherical surface. The seventh surface S7 and the eighth surface S8 may have aspheric coefficients as shown in Table 2 below.

The fifth lens 150 may have positive (+) refractive power on the optical axis OA. The ninth surface S9 of the fifth lens 150 may have a convex shape on the optical axis OA, and the tenth surface S10 may have a convex shape on the optical axis OA. The fifth lens 150 may have a shape in which both sides are convex on the optical axis OA. The ninth surface S9 may be an aspherical surface, and the tenth surface S10 may be an aspherical surface. The ninth surface S9 and the tenth surface S10 may have aspheric coefficients as shown in Table 2 below. The sixth lens 160 may have negative refractive power on the optical axis OA. The eleventh surface S11 of the sixth lens 160 may have a concave shape on the optical axis OA, and the twelfth surface S12 may have a concave shape on the optical axis OA. The sixth lens 160 may have a shape in which both sides are concave of the optical axis OA. The eleventh surface S11 may be an aspherical surface, and the twelfth surface S12 may be an aspherical surface. The eleventh surface S11 and the twelfth surface S12 may have aspheric coefficients as shown in Table 2 below.

The seventh lens 170 may have positive (+) refractive power on the optical axis OA. The thirteenth surface S13 of the seventh lens 170 may have a convex shape on the optical axis OA, and the fourteenth surface S14 may have a convex shape on the optical axis OA. The seventh lens 170 may have a shape in which both sides are convex on the optical axis OA. The thirteenth surface S13 may be an aspherical surface, and the fourteenth surface S14 may be an aspherical surface. The thirteenth surface S13 and the fourteenth surface S14 may have aspheric coefficients as shown in Table 2 below. The eighth lens 180 may have negative refractive power on the optical axis OA. The fifteenth surface S15 of the eighth lens 180 may have a concave shape on the optical axis OA, and the sixteenth surface S16 may have a concave shape on the optical axis OA. The eighth lens 180 may have a shape in which both sides are concave of the optical axis OA. The fifteenth surface S15 may be an aspherical surface, and the sixteenth surface S16 may be an aspherical surface. The fifteenth surface S15 and the sixteenth surface S16 may have aspherical coefficients as shown in Table 2 below.

The eighth lens 180 may include an inflection point. In detail, the above-described first inflection point may be disposed on the sixteenth surface S16 of the eighth lens 180. The first inflection point may be disposed at a position that is about 40% to about 85% of the effective radius of the sixteenth surface S16 of the eighth lens 180 with respect to the optical axis OA. In the optical system according to the first embodiment, the optical system may be disposed at a position that is about 61% of the effective radius of the sixteenth surface S16 of the eighth lens 180 based on the first inflection point optical axis OA.

The ninth lens 190 may have negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex on the optical axis OA toward the object. The seventeenth surface S17 may be an aspherical surface, and the eighteenth surface S18 may be an aspherical surface. The seventeenth surface S17 and the eighteenth surface S18 may have aspherical coefficients as shown in Table 2 below.

The ninth lens 190 may include an inflection point. In detail, the above-described second inflection point may be disposed on the seventeenth surface S17 of the ninth lens 190. The second inflection point may be disposed at a position that is about 15% to about 60% of the effective radius of the seventeenth surface S17 of the ninth lens 190 with respect to the optical axis OA. In the optical system according to the first embodiment, the second inflection point may be disposed at a position that is about 35% of the effective radius of the seventeenth surface S17 of the ninth lens 190 based on the optical axis OA.

The third inflection point described above may be disposed on the eighteenth surface S18 of the ninth lens 190. The third inflection point may be disposed at a position that is about 30% to about 80% of the effective radius of the eighteenth surface S18 of the ninth lens 190 with respect to the optical axis OA. In the optical system according to the first embodiment, the third inflection point may be located at a position that is about 53% of the effective radius of the eighteenth surface S18 of the ninth lens 190 with respect to the optical axis OA.

In the optical system 1000 according to the first embodiment, the plurality of lenses 100 may include a plurality of lens groups. For example, the plurality of lenses 100 may include a first lens group G1 disposed between the object and the aperture stop and a second lens group G2 disposed between the aperture stop and the image sensor 300. That is, the first lens group G1 may include the first lens 110, and the second lens group G2 may include the second to ninth lenses 120, 130, 140, 150, 160, 170, 180, and 190. At this time, each of the composite focal length of the first lens group G1 and the composite focal length of the second lens group G2 may have a positive value. Accordingly, the optical system 1000 according to the first embodiment may have improved distortion aberration control characteristics.

The aspherical coefficient values of each lens surface in the optical system 1000 according to the first embodiment are shown in Table 2 below.

TABLE 2

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| R | 2.881 | 3.020 | 3.187 | −50.277 | 10.988 | 3.378 | 17.389 | 120.657 | 9.780 |
| K | −1.460 | −3.014 | −0.138 | 100 | −68.936 | −2.343 | 27.787 | −100 | −12.670 |
| A | −2.08E−03 | −8.58E−03 | −1.32E−02 | −2.12E−03 | −9.15E−04 | −6.07E−04 | −6.56E−03 | −1.66E−02 | −1.94E−02 |
| B | 4.07E−04 | −6.54E−04 | −1.58E−03 | −2.21E−03 | 5.64E−04 | 2.25E−03 | −3.24E−03 | −1.59E−03 | 2.87E−04 |
| C | −7.20E−04 | 1.16E−04 | 3.58E−04 | −2.53E−04 | −4.06E−04 | −1.59E−04 | 4.43E−04 | −6.79E−05 | 2.68E−05 |
| D | 1.25E−04 | −6.28E−05 | −9.61E−05 | 5.24E−05 | 1.57E−04 | 2.73E−05 | −1.57E−05 | 4.68E−06 | 2.86E−05 |
| E | −5.74E−07 | −1.27E−04 | −1.36E−04 | 9.16E−06 | −8.17E−07 | 7.18E−06 | 1.01E−05 | 1.35E−05 | −6.27E−06 |
| F | −1.07E−06 | 8.01E−05 | 3.02E−05 | 2.18E−05 | 9.80E−06 | 3.52E−07 | 9.15E−06 | 9.58E−07 | 2.64E−07 |
| G | −1.18E−05 | −2.48E−06 | 3.35E−05 | 4.82E−06 | −3.35E−06 | −1.31E−06 | −6.68E−07 | 1.77E−07 | 8.45E−08 |
| H | 6.06E−06 | −9.01E−07 | −2.93E−06 | −5.31E−08 | −1.20E−06 | −6.20E−07 | −2.85E−07 | −3.53E−08 | 3.77E−08 |
| J | −8.43E−07 | −4.45E−07 | −1.44E−06 | −4.74E−07 | 3.25E−07 | 3.21E−07 | −5.93E−08 | −4.18E−08 | 1.66E−09 |
| | L5 | L6 | | L7 | | L8 | | L9 | |
| | S10 | S11 | S12 | S13 | S14 | S15 | S16 | S17 | S18 |
| R | −107.295 | −7.951 | 95.604 | 18.227 | −2.691 | −42.420 | 4.018 | 4.942 | 2.199 |
| K | 100 | −25.919 | 100 | −73.678 | −4.615 | −100 | −5.544 | −58.238 | −9.638 |
| A | −1.37E−02 | −1.33E−02 | −1.07E−02 | 6.00E−06 | 8.56E−03 | −5.82E−03 | −7.10E−03 | −1.40E−02 | −1.51E−02 |
| B | −1.80E−03 | 4.45E−04 | −1.45E−03 | −2.34E−03 | −1.39E−03 | −2.52E−03 | −1.19E−03 | −1.82E−04 | 1.03E−03 |
| C | 8.32E−04 | −4.41E−06 | 9.04E−04 | 3.94E−04 | −2.06E−05 | 5.13E−04 | 2.19E−04 | 1.85E−04 | −3.12E−05 |
| D | −1.56E−04 | 3.77E−05 | −1.62E−04 | −4.77E−05 | 2.20E−05 | −3.90E−05 | −1.91E−05 | −1.33E−05 | 1.05E−06 |
| E | 1.86E−05 | −3.94E−06 | 1.64E−05 | 3.23E−06 | −2.49E−06 | 2.19E−06 | 7.45E−07 | 3.93E−07 | −2.38E−08 |
| F | −9.74E−07 | 2.32E−07 | −8.84E−07 | −3.92E−07 | 7.54E−08 | −1.45E−07 | −1.80E−08 | −6.08E−09 | 1.13E−10 |
| G | −1.26E−08 | 2.19E−08 | 1.65E−08 | 4.45E−09 | −1.85E−09 | −7.09E−09 | 5.06E−10 | 1.09E−11 | −1.99E−11 |
| H | −3.57E−09 | 7.58E−09 | 4.73E−10 | 1.41E−09 | −1.55E−10 | −7.74E−10 | −9.99E−12 | 7.34E−14 | −4.84E−13 |
| J | 4.02E−09 | −7.48E−10 | 7.40E−10 | 2.55E−10 | −4.54E−11 | 9.36E−11 | −1.04E−12 | −1.50E−14 | −1.74E−14 |

Additionally, in the optical system 1000 according to the first embodiment, the distance (first distance) between the first lens 110 and the second lens 120 may be as shown in Table 3 below.

TABLE 3

| Height (mm) in the vertical | | Height (mm) in the vertical |
|---|---|---|
| direction of the optical axis | | direction of the optical axis |
| from the optical axis on the | | from the optical axis on the |
| sensor-side surface of the first | First distance | object-side surface of the |
| lens | (d12) (mm) | second lens |
| 0 | 0.2652 | 0 |
| 0.1 | 0.2652 | 0.1 |
| 0.2 | 0.2649 | 0.2 |
| 0.3 | 0.2645 | 0.3 |
| 0.4 | 0.2641 | 0.4 |
| 0.5 | 0.2635 | 0.5 |
| 0.6 | 0.2631 | 0.6 |
| 0.7 | 0.2627 | 0.7 |
| 0.8 (CP1) | 0.2625 | 0.8 (CP1) |
| 0.9 | 0.2626 | 0.9 |
| 1 | 0.2630 | 1 |
| 1.1 | 0.2638 | 1.1 |
| 1.2 | 0.2650 | 1.2 |
| 1.3 | 0.2668 | 1.3 |
| 1.4 | 0.2695 | 1.4 |
| 1.5 (CP2) | 0.2741 | 1.5 (CP2) |

Referring to Table 3, the first distance may become smaller as it moves from the optical axis OA toward the first point CP1 located on the second surface S2. The first point CP1 may be disposed at a position that is about 40% to about 95% of the effective radius of the third surface S3 based on the optical axis OA, for example, at a position that is about 53.3% of the effective radius of the third surface S3. The first distance may increase from the first point CP1 toward the second point CP2, which is the end of the effective diameter of the third surface S3. Here, a value represented by the second point CP2 is the effective radius value of the second surface S2 having a small effective diameter among the sensor-side surface (second surface S2) of the first lens 110 and the object-side surface (third surface S3) of the second lens 120 facing each other, and may mean ½ of the effective diameter of the second surface S2 shown in Table 1. The first distance may have a maximum value at the second point CP2 and a minimum value at the first point CP1. The maximum value of the first distance may be about 1.03 to about 1.5 times the minimum value. For example, in the first embodiment, the maximum value of the first distance may be about 1.04 times the minimum value. In the optical system 1000 according to the first embodiment, the first lens 110 and the second lens 120 may have the first distance that satisfies the above range depending on the regions. Accordingly, the optical system 1000 may have good optical performance by allowing light incident through the first lens 110 and the second lens 120 to move along a set path.

In the optical system 1000 according to the first embodiment, a distance (second distance) between the fifth lens 150 and the sixth lens 160 may be as shown in Table 4 below.

TABLE 4

| Height (mm) in the vertical | | Height (mm) in the vertical |
|---|---|---|
| direction of the optical axis | Second | direction of the optical axis |
| from the optical axis on the | distance | from the optical axis on the |
| sensor-side surface of the fifth | (d56) | object-side surface of the sixth |
| lens | (mm) | lens |
| 0 | 0.2054 | 0 |
| 0.1 | 0.2048 | 0.1 |
| 0.2 | 0.2031 | 0.2 |
| 0.3 | 0.2002 | 0.3 |
| 0.4 | 0.1963 | 0.4 |
| 0.5 | 0.1913 | 0.5 |
| 0.6 | 0.1853 | 0.6 |
| 0.7 | 0.1785 | 0.7 |
| 0.8 | 0.1710 | 0.8 |
| 0.9 | 0.1629 | 0.9 |
| 1 | 0.1544 | 1 |
| 1.1 | 0.1456 | 1.1 |
| 1.2 | 0.1367 | 1.2 |
| 1.3 | 0.1279 | 1.3 |
| 1.4 | 0.1194 | 1.4 |
| 1.5 | 0.1115 | 1.5 |
| 1.6 | 0.1045 | 1.6 |
| 1.7 | 0.0987 | 1.7 |
| 1.8 | 0.0946 | 1.8 |
| 1.965 (CP3) | 0.0927 | 1.965 (CP3) |

Referring to Table 4, the second distance may become smaller as it moves from the optical axis OA toward the third point CP3, which is the end of the effective diameter of the tenth surface S10. Here, a value represented by the third point CP3 is the effective radius value of the tenth surface S10 having a small effective diameter among the sensor-side surface (tenth surface S10) of the fifth lens 150 and the object-side surface (eleventh surface S11) of the sixth lens 160 facing each other, and may mean ½ of the effective diameter of the tenth surface S10 shown in Table 1. The second distance may have a maximum value at the optical axis OA and a minimum value at the third point CP3. The maximum value of the second distance may be about 1.5 to about 3 times the minimum value. For example, in the first embodiment, the maximum value of the second distance may be about 2.22 times the minimum value. In the optical system 1000 according to the first embodiment, the fifth lens 150 and the sixth lens 160 may have a second distance that satisfies the above range depending on the regions. Accordingly, the optical system 1000 may have improved aberration control characteristics and good optical performance in the periphery portion of the FOV. In the optical system 1000 according to the first embodiment, the sixth lens 160 and a distance (third distance) between the seventh lenses 170 may be as shown in Table 5 below.

TABLE 5

| Height (mm) in the vertical | | Height (mm) in the vertical |
|---|---|---|
| direction of the optical axis | Third | direction of the optical axis |
| from the optical axis on the | distance | from the optical axis on the |
| sensor-side surface of the sixth | (d67) | object-side surface of the |
| lens | (mm) | seventh lens |
| 0 | 0.3210 | 0 |
| 0.1 | 0.3212 | 0.1 |
| 0.2 | 0.3219 | 0.2 |
| 0.3 | 0.3231 | 0.3 |
| 0.4 | 0.3248 | 0.4 |
| 0.5 | 0.3271 | 0.5 |
| 0.6 | 0.3301 | 0.6 |
| 0.7 | 0.3340 | 0.7 |
| 0.8 | 0.3387 | 0.8 |
| 0.9 | 0.3444 | 0.9 |
| 1 | 0.3512 | 1 |
| 1.1 | 0.3591 | 1.1 |
| 1.2 | 0.3681 | 1.2 |
| 1.3 | 0.3782 | 1.3 |
| 1.4 | 0.3891 | 1.4 |
| 1.5 | 0.4006 | 1.5 |
| 1.6 | 0.4123 | 1.6 |
| 1.7 | 0.4237 | 1.7 |
| 1.8 | 0.4339 | 1.8 |
| 1.9 | 0.4418 | 1.9 |
| 2 (CP5) | 0.4459 | 2 (CP5) |
| 2.1 | 0.4440 | 2.1 |
| 2.194 (CP6) | 0.4326 | 2.194 (CP6) |

Referring to Table 5, the third distance may increase from the optical axis OA toward the fifth point CP5 located on the twelfth surface S12. The fifth point CP5 may be located at a position that is about 80% to about 95% of the effective radius of the tenth surface S10 with respect to the optical axis OA, and may be arranged at a position that is about 91.2% of the effective radius of the tenth surface S10. The third distance may become smaller from the fifth point CP5 toward the sixth point CP6, which is the end of the effective diameter of the twelfth surface S12. Here, a value represented by the sixth point CP6 is the effective radius value of the twelfth surface S12 having a small effective diameter among the sensor-side surface (twelfth surface S12) of the sixth lens 160 and the object-side surface (thirteenth surface S13) of the seventh lens 170 facing each other, and may mean ½ of the effective diameter of the twelfth surface S12 shown in Table 1. The third distance may have a maximum value at the fifth point CP5 and a minimum value at the optical axis OA. The maximum value of the third distance may be about 1.2 times to about 2 times the minimum value. For example, in the first embodiment, the maximum value of the third distance may be about 1.39 times the minimum value. Accordingly, the optical system 1000 may have a slim structure by reducing the size of the effective diameter of the seventh lens 170, and the distortion characteristics of the optical system 1000 may be controlled. In addition, the third lens 170 may have a slim structure. In the optical system 1000 according to the first embodiment, the distance (fourth distance) between the seventh lens 170 and the eighth lens 180 may be as shown in Table 6 below.

TABLE 6

| Height (mm) in the vertical | | Height (mm) in the vertical |
|---|---|---|
| direction of the optical axis | | direction of the optical axis |
| from the optical axis on the | | from the optical axis on the |
| sensor-side surface of the | Fourth distance | object-side surface of the |
| seventh lens | (d78) (mm) | eighth lens |
| 0 | 0.1000 | 0 |
| 0.1 | 0.1017 | 0.1 |
| 0.2 | 0.1069 | 0.2 |
| 0.3 | 0.1154 | 0.3 |
| 0.4 | 0.1269 | 0.4 |
| 0.5 | 0.1412 | 0.5 |
| 0.6 | 0.1580 | 0.6 |
| 0.7 | 0.1768 | 0.7 |
| 0.8 | 0.1971 | 0.8 |
| 0.9 | 0.2185 | 0.9 |
| 1 | 0.2404 | 1 |
| 1.1 | 0.2623 | 1.1 |
| 1.2 | 0.2836 | 1.2 |
| 1.3 | 0.3039 | 1.3 |
| 1.4 | 0.3227 | 1.4 |
| 1.5 | 0.3395 | 1.5 |
| 1.6 | 0.3540 | 1.6 |
| 1.7 | 0.3660 | 1.7 |
| 1.8 | 0.3754 | 1.8 |
| 1.9 | 0.3821 | 1.9 |
| 2 | 0.3862 | 2 |
| 2.1 | 0.3882 | 2.1 |
| 2.2 (CP7) | 0.3883 | 2.2 (CP7) |
| 2.3 | 0.3869 | 2.3 |
| 2.4 | 0.3844 | 2.4 |
| 2.5 | 0.3809 | 2.5 |
| 2.592 (CP8) | 0.3764 | 2.592 (CP8) |

Referring to Table 6, the fourth distance may increase from the optical axis OA toward the seventh point CP7 located on the fourteenth surface S14. The seventh point CP7 may be placed at a position that is about 60% to about 90% of the effective radius of the fourteenth surface S14 with respect to the optical axis OA, and for example, may be disposed at a position that is about 84.8%. The fourth distance may become smaller from the seventh point CP7 toward the eighth point CP8, which is the end of the effective diameter of the fourteenth surface S14. Here, a value represented by the eighth point CP8 is the effective radius value of the fourteenth surface S14 having a small effective diameter among the sensor-side surface (fourteenth surface S14) of the seventh lens 170 and the object-side surface (fifteenth surface S15) of the eighth lens 180 facing each other, and may mean ½ of the effective diameter of the fourteenth surface S14 shown in Table 1. The fourth distance may have a maximum value at the seventh point CP7 and a minimum value at the optical axis OA. The maximum value of the fourth distance may be about 2.5 times to about 4.5 times the minimum value. For example, in the first embodiment, the maximum value of the fourth distance may be about 3.88 times the minimum value. In the optical system 1000 according to the first embodiment, the seventh lens 170 and the eighth lens 180 may have a fourth distance that satisfies the above range depending on the regions. Accordingly, the optical system 1000 may control the distortion characteristics of the optical system 1000 and have good optical performance in the center and periphery portions of the FOV.

In the optical system 1000 according to the first embodiment, a distance (fifth distance) between the eighth lens 180 and the ninth lens 190 may be as shown in Table 7 below.

TABLE 7

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | Fifth distance | surface of the ninth |
| eighth lens | (d89) (mm) | lens |
| 0 | 0.4090 | 0 |
| 0.1 | 0.4088 | 0.1 |
| 0.2 | 0.4080 | 0.2 |
| 0.3 | 0.4065 | 0.3 |
| 0.4 | 0.4040 | 0.4 |
| 0.5 | 0.4004 | 0.5 |
| 0.6 | 0.3953 | 0.6 |
| 0.7 | 0.3887 | 0.7 |
| 0.8 | 0.3803 | 0.8 |
| 0.9 | 0.3700 | 0.9 |
| 1 | 0.3579 | 1 |
| 1.1 | 0.3438 | 1.1 |
| 1.2 | 0.3279 | 1.2 |
| 1.3 | 0.3101 | 1.3 |
| 1.4 | 0.2904 | 1.4 |
| 1.5 | 0.2692 | 1.5 |
| 1.6 | 0.2464 | 1.6 |
| 1.7 | 0.2223 | 1.7 |
| 1.8 | 0.1974 | 1.8 |
| 1.9 | 0.1718 | 1.9 |
| 2 | 0.1461 | 2 |
| 2.1 | 0.1210 | 2.1 |
| 2.2 | 0.0971 | 2.2 |
| 2.3 | 0.0754 | 2.3 |
| 2.4 | 0.0569 | 2.4 |
| 2.5 | 0.0429 | 2.5 |
| 2.6 | 0.0349 | 2.6 |
| 2.7 (CP10) | 0.0347 | 2.7 (CP10) |
| 2.8 | 0.0444 | 2.8 |
| 2.9 | 0.0663 | 2.9 |
| 3 | 0.1032 | 3 |
| 3.1 | 0.1585 | 3.1 |
| 3.2 | 0.2361 | 3.2 |
| 3.303 (CP11) | 0.3409 | 3.303 (CP11) |

Referring to Table 7, the fifth distance may become smaller as it moves from the optical axis OA toward the tenth point CP10 located on the sixteenth surface S16. The tenth point CP10 may be disposed at a position that is about 70% to about 90% of the effective radius of the sixteenth surface S16 based on the optical axis OA. For example, in the first embodiment, the tenth point CP10 may be placed at a position of about 81.7%. The fourth distance may increase from the tenth point CP10 toward the eleventh point CP11, which is the end of the effective diameter of the sixteenth surface S16. Here, a value represented by the eleventh point CP11 is the effective radius value of the sixteenth surface S16 having a small effective diameter among the sensor-side surface (sixteenth surface S16) of the eighth lens 180 and the object-side surface (seventeenth surface) of the ninth lens 190 facing each other, and may mean ½ of the effective diameter of the sixteenth surface S16 shown in Table 1. The fifth distance may have a maximum value at the optical axis OA and a minimum value at the tenth point CP10. The maximum value of the fifth distance may be about 10 to about 20 times the minimum value. For example, in the first embodiment, the maximum value of the fifth distance may be about 11.78 times the minimum value. In the optical system 1000 according to the first embodiment, the eighth lens 180 and the ninth lens 190 may have a fifth distance that satisfies the above range depending on the regions. Accordingly, the optical system 1000 may have improved chromatic aberration and distortion aberration control characteristics, and may have good optical performance in the center and periphery portions of the FOV.

FIG. 2 is a graph of MTF versus spatial frequency of the optical system 1000 according to the first embodiment, FIG. 3 is a graph of diffraction MTF of the optical system according to the first embodiment, and FIG. 4 is an aberration graph of the optical system according to the first embodiment. FIG. 2 measures the MTF characteristics according to the spatial frequency, and when the MTF value is 1, it means that it has the best resolution, and when the MTF value decreases from 1, it means that the resolution decreases.

The aberration graph in FIG. 4 is a graph measuring spherical aberration, astigmatic field curves, and distortion from left to right. In FIG. 4, the X-axis may represent focal length (mm) and distortion aberration (%), and the Y-axis may represent the height of the image. Additionally, the graphs for spherical aberration, astigmatism, and distortion aberration are graphs for light in wavelength bands of about 486 nm, about 587 nm, and about 656 nm. In the aberration diagram of FIG. 4, it may be interpreted that the closer each curve is to the Y-axis, the better the aberration correction function, and referring to FIG. 4, it may be seen that measurement values of the optical system 1000 according to the embodiment are adjacent to the Y-axis in most regions. That is, the optical system 1000 according to the first embodiment has improved resolution and may have good optical performance in the center and periphery portions of the FOV.

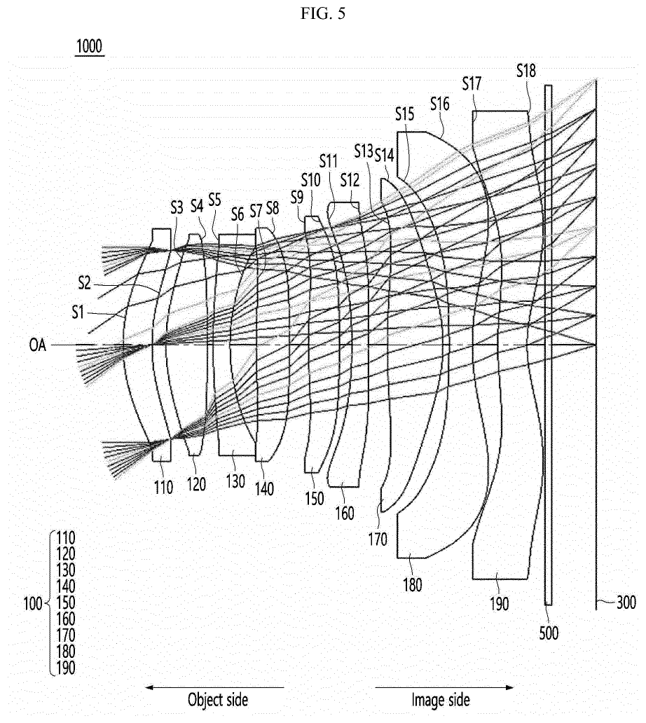

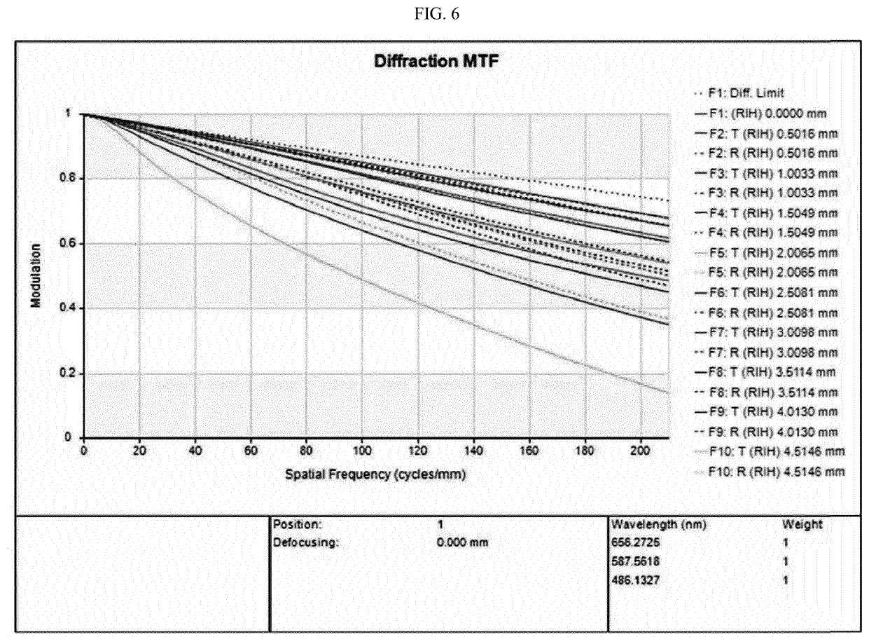

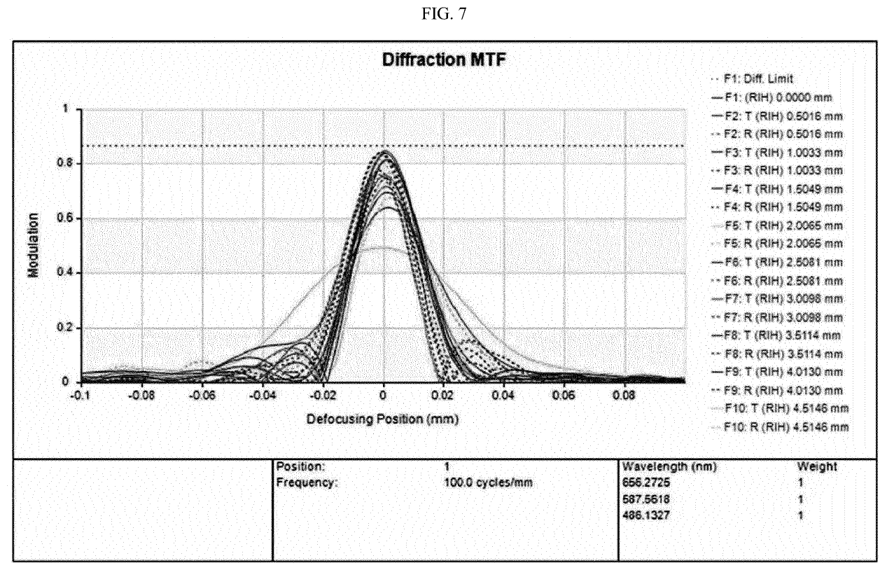

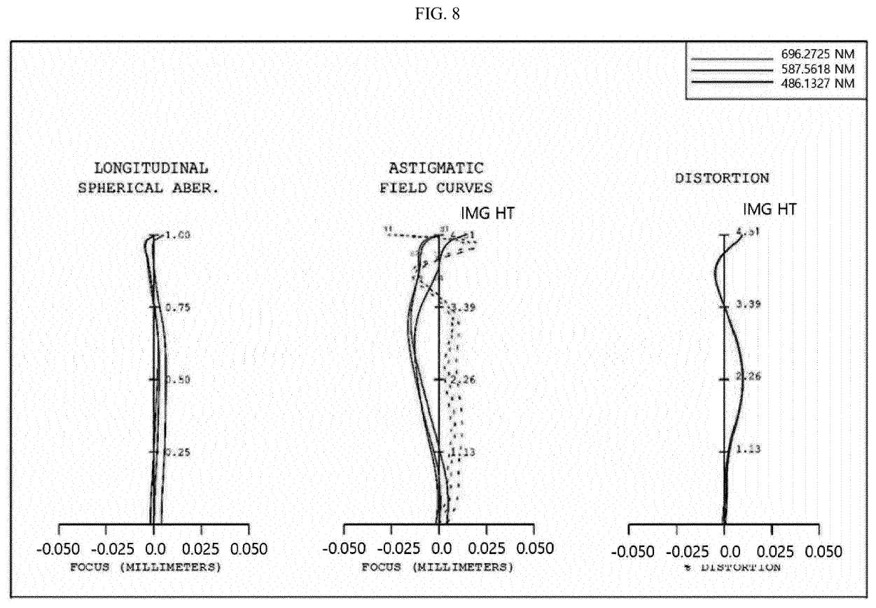

FIG. 5 is a configuration diagram of an optical system according to the second embodiment. In addition, FIG. 6 is a graph of the MTF of the spatial frequency of the optical system according to the second embodiment, FIG. 7 is a graph of the diffraction MTF of the optical system according to the second embodiment, and FIG. 8 is an aberration graph of the MTF of the optical system according to the second embodiment. Referring to FIGS. 5 to 7, the optical system 1000 according to the second embodiment may include a first lens 110, a second lens 120, a third lens 130, a fourth lens 140, a fifth lens 150, a sixth lens 160, a seventh lens 170, an eighth lens 180, a ninth lens 190, and an image sensor 300. The first to ninth lenses 110, 120, 130, 140, 150, 160, 170, 180, and 190 may be sequentially arranged along the optical axis OA of the optical system 1000.

In the optical system 1000 according to the second embodiment, an aperture stop may be disposed between the first lens 110 and the second lens 120. The sensor-side surface (second surface S2) of the first lens 110 may function as an aperture stop. A filter 500 may be disposed between the plurality of lenses 100 and the image sensor 300. In detail, the filter 500 may be disposed between the ninth lens 190 and the image sensor 300.

TABLE 8

| | | Radius of | Thickness (mm)/ | Reflective | Abbe | Effective |
|---|---|---|---|---|---|---|
| Lens | Surface | curvature (mm) | Distance (mm) | Index | number | diameter (mm) |
| Lens 1 | S1 | 2.859 | 0.483 | 1.562 | 63.74 | 3.580 |
| | S2 | 3.001 | 0.232 | | | 3.200 |
| | (Stop) | | | | | |
| Lens 2 | S3 | 3.251 | 0.690 | 1.620 | 60.32 | 3.395 |
| | S4 | −46.541 | 0.100 | | | 3.420 |
| Lens 3 | S5 | 11.528 | 0.280 | 1.755 | 27.57 | 3.411 |
| | S6 | 3.452 | 0.440 | | | 3.368 |
| Lens 4 | S7 | 16.696 | 0.547 | 1.744 | 44.85 | 3.363 |
| | S8 | 802.754 | 0.323 | | | 3.598 |
| Lens 5 | S9 | 10.380 | 0.512 | 1.744 | 44.85 | 3.812 |
| | S10 | −56.608 | 0.211 | | | 3.955 |
| Lens 6 | S11 | −7.769 | 0.280 | 1.755 | 27.57 | 4.000 |
| | S12 | 94.010 | 0.314 | | | 4.391 |
| Lens 7 | S13 | 13.002 | 0.928 | 1.705 | 48.29 | 4.877 |
| | S14 | −2.717 | 0.100 | | | 5.241 |
| Lens 8 | S15 | −15.593 | 0.386 | 1.521 | 54.76 | 5.426 |
| | S16 | 3.894 | 0.427 | | | 6.580 |
| Lens 9 | S17 | 5.296 | 0.488 | 1.747 | 36.95 | 6.808 |
| | S18 | 2.316 | 0.297 | | | 7.559 |
| Filter | | Infinity | 0.110 | | | 7.920 |
| | | Infinity | 0.750 | | | 8.008 |
| Image | | Infinity | 0.000 | | | 9.031 |
| sensor | | | | | | |

Table 8 shows the radius of curvature on the optical axis OA of the first to ninth lenses 110, 120, 130, 140, 140, 150, 160, 170, 180, and 190 according to a second embodiment, the thickness of the lens, the distance between the lenses, the refractive index, Abbe Number, and the size of the effective diameter (CA: clear aperture). The first lens 110 of the optical system 1000 according to the second embodiment may have positive (+) refractive power on the optical axis OA. The first surface S1 of the first lens 110 may have a convex shape on the optical axis OA, and the second surface S2 may have a concave shape on the optical axis OA. The first lens 110 may have a meniscus shape that is convex on the optical axis OA toward the object. The first surface S1 and the second surface S2 may have aspheric coefficients as shown in Table 9 below. The second lens 120 may have positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspherical coefficients as shown in Table 9 below. The third lens 130 may have negative refractive power on the optical axis OA. The fifth surface S5 of the third lens 130 may have a convex shape on the optical axis OA, and the sixth surface S6 may have a concave shape on the optical axis OA. The third lens 130 may have a meniscus shape that is convex on the optical axis OA toward the object. The fifth surface S5 may be an aspherical surface, and the sixth surface S6 may be an aspherical surface. The fifth surface S5 and the sixth surface S6 may have aspheric coefficients as shown in Table 9 below.

The fourth lens 140 may have positive (+) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape that is convex on the optical axis OA toward the object. The seventh surface S7 may be an aspherical surface, and the eighth surface S8 may be an aspherical surface. The seventh surface S7 and the eighth surface S8 may have aspherical coefficients as shown in Table 9 below. The fifth lens 150 may have positive (+) refractive power on the optical axis OA. The ninth surface S9 of the fifth lens 150 may have a convex shape on the optical axis OA, and the tenth surface S10 may have a convex shape on the optical axis OA. The fifth lens 150 may have a shape in which both sides are convex on the optical axis OA. The ninth surface S9 may be an aspherical surface, and the tenth surface S10 may be an aspherical surface. The ninth surface S9 and the tenth surface S10 may have aspheric coefficients as shown in Table 9 below.

The sixth lens 160 may have negative refractive power on the optical axis OA. The eleventh surface S11 of the sixth lens 160 may have a concave shape on the optical axis OA, and the twelfth surface S12 may have a concave shape on the optical axis OA. The sixth lens 160 may have a shape in which both sides are concave of the optical axis OA. The eleventh surface S11 may be an aspherical surface, and the twelfth surface S12 may be an aspherical surface. The eleventh surface S11 and the twelfth surface S12 may have aspheric coefficients as shown in Table 9 below. The seventh lens 170 may have positive (+) refractive power on the optical axis OA. The thirteenth surface S13 of the seventh lens 170 may have a convex shape on the optical axis OA, and the fourteenth surface S14 may have a convex shape on the optical axis OA. The seventh lens 170 may have a shape in which both sides are convex on the optical axis OA. The thirteenth surface S13 may be an aspherical surface, and the fourteenth surface S14 may be an aspherical surface. The thirteenth surface S13 and the fourteenth surface S14 may have aspheric coefficients as shown in Table 9 below.

The eighth lens 180 may have negative refractive power on the optical axis OA. The fifteenth surface S15 of the eighth lens 180 may have a concave shape on the optical axis OA, and the sixteenth surface S16 may have a concave shape on the optical axis OA. The eighth lens 180 may have a shape in which both sides are concave of the optical axis OA. The fifteenth surface S15 may be an aspherical surface, and the sixteenth surface S16 may be an aspherical surface. The fifteenth surface S15 and the sixteenth surface S16 may have aspheric coefficients as shown in Table 9 below. The eighth lens 180 may include an inflection point. In detail, the above-described first inflection point may be disposed on the sixteenth surface S16 of the eighth lens 180. The first inflection point may be disposed at a position that is about 40% to about 85% of the effective radius of the sixteenth surface S16 of the eighth lens 180 with respect to the optical axis OA. In the optical system according to the second embodiment, the first inflection point may be located at a position that is about 66% of the effective radius of the sixteenth surface S16 of the eighth lens 180 with respect to the optical axis OA.

The ninth lens 190 may have negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex on the optical axis OA toward the object. The seventeenth surface S17 may be an aspherical surface, and the eighteenth surface S18 may be an aspherical surface. The seventeenth surface S17 and the eighteenth surface S18 may have aspheric coefficients as shown in Table 9 below.

The ninth lens 190 may include an inflection point. In detail, the above-described second inflection point may be disposed on the seventeenth surface S17 of the ninth lens 190. The second inflection point may be disposed at a position that is about 15% to about 60% of the effective radius of the seventeenth surface S17 of the ninth lens 190 with respect to the optical axis OA, and for example, may be disposed at a position that is about 38%. The third inflection point described above may be disposed on the eighteenth surface S18 of the ninth lens 190. The third inflection point may be disposed at a position that is about 30% to about 80% of the effective radius of the eighteenth surface S18 of the ninth lens 190 with respect to the optical axis OA. The third inflection point may be located at a position that is about 51% of the effective radius of the eighteenth surface S18 of the ninth lens 190 with respect to the optical axis OA.

In the optical system 1000 according to the second embodiment, the plurality of lenses 100 may include a plurality of lens groups. For example, the plurality of lenses 100 may include a first lens group G1 disposed between the object and the aperture stop and a second lens group G2 disposed between the aperture stop and the image sensor 300. That is, the first lens group G1 may include the first lens 110, and the second lens group G2 may include the second to ninth lenses 120, 130, 140, 150, 160, 170, 180, and 190. At this time, each of the composite focal length of the first lens group G1 and the composite focal length of the second lens group G2 may have a positive value. Accordingly, the optical system 1000 according to the second embodiment may have improved distortion aberration control characteristics.

The aspheric coefficient values of each lens surface in the optical system 1000 according to the second embodiment are shown in Table 9 below.

TABLE 9

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| R | 2.859 | 3.001 | 3.251 | −46.541 | 11.528 | 3.452 | 16.696 | 802.754 | 10.380 |
| K | −1.337 | −2.914 | −0.288 | 98.980 | −76.480 | −2.317 | 22.091 | −100.000 | −10.482 |
| A | −1.53E−03 | −8.49E−03 | −1.39E−02 | −2.15E−03 | −1.00E−03 | −4.31E−04 | −6.68E−03 | −1.68E−02 | −1.93E−02 |
| B | 5.47E−04 | −7.83E−04 | −1.73E−03 | −2.34E−03 | 5.57E−04 | 2.44E−03 | −3.39E−03 | −1.64E−03 | 2.85E−04 |
| C | −7.17E−04 | 2.89E−05 | 3.38E−04 | −2.78E−04 | −4.00E−04 | −9.51E−05 | 3.92E−04 | −9.97E−05 | 2.92E−05 |
| D | 1.19E−04 | −9.01E−05 | −1.02E−04 | 4.68E−05 | 1.64E−04 | 4.22E−05 | −2.74E−05 | −1.49E−06 | 2.98E−05 |
| E | −2.83E−06 | −1.32E−04 | −1.40E−04 | 7.59E−06 | 1.70E−06 | 9.23E−06 | 7.64E−06 | 1.34E−05 | −6.03E−06 |
| F | −1.53E−06 | 8.02E−05 | 2.77E−05 | 2.12E−05 | 9.89E−06 | 6.93E−08 | 8.60E−06 | 1.28E−06 | 2.68E−07 |
| G | −1.19E−05 | −1.97E−06 | 3.28E−05 | 4.43E−06 | −3.71E−06 | −1.64E−06 | −7.48E−07 | 2.65E−07 | 6.81E−08 |
| H | 6.09E−06 | −6.50E−07 | −2.96E−06 | −3.22E−07 | −1.42E−06 | −7.50E−07 | −2.34E−07 | −4.07E−08 | 3.09E−08 |
| J | −8.17E−07 | −3.71E−07 | −1.30E−06 | −6.54E−07 | 2.47E−07 | 2.96E−07 | 6.84E−09 | −5.82E−08 | 1.79E−10 |
| | L5 | L6 | | L7 | | L8 | | L9 | |
| | S10 | S11 | S12 | S13 | S14 | S15 | S16 | S17 | S18 |
| R | −56.608 | −7.769 | 94.010 | 13.002 | −2.717 | −15.593 | 3.894 | 5.296 | 2.316 |
| K | 100.000 | −22.228 | 100.000 | −55.721 | −5.327 | −57.719 | −5.505 | −61.819 | −10.233 |
| A | −1.42E−02 | −1.33E−02 | −1.06E−02 | 5.15E−05 | 8.60E−03 | −5.49E−03 | −7.17E−03 | −1.33E−02 | −1.55E−02 |
| B | −1.89E−03 | 4.70E−04 | −1.45E−03 | −2.36E−03 | −1.34E−03 | −2.49E−03 | −1.08E−03 | −1.96E−04 | 1.07E−03 |
| C | 8.19E−04 | −1.08E−07 | 9.05E−04 | 3.96E−04 | −1.56E−05 | 5.15E−04 | 2.17E−04 | 1.84E−04 | −3.14E−05 |
| D | −1.58E−04 | 3.85E−05 | −1.62E−04 | −4.73E−05 | 2.22E−05 | −3.85E−05 | −1.94E−05 | −1.33E−05 | 1.02E−06 |
| E | 1.83E−05 | −3.76E−06 | 1.64E−05 | 3.23E−06 | −2.50E−06 | 2.20E−06 | 7.41E−07 | 3.91E−07 | −2.51E−08 |
| F | −1.02E−06 | 2.69E−07 | −8.84E−07 | −3.96E−07 | 7.22E−08 | −1.47E−07 | −1.72E−08 | −6.18E−09 | 6.53E−11 |
| G | −1.44E−08 | 2.87E−08 | 1.74E−08 | 3.79E−09 | −2.46E−09 | −7.53E−09 | 5.88E−10 | 6.78E−12 | −2.16E−11 |
| H | −1.56E−09 | 8.90E−09 | 9.64E−10 | 1.38E−09 | −2.58E−10 | −7.98E−10 | −5.18E−12 | −1.11E−13 | −5.29E−13 |
| J | 4.87E−09 | −3.37E−10 | 9.07E−10 | 2.63E−10 | −6.10E−11 | 9.67E−11 | −8.71E−13 | −2.86E−14 | −1.68E−14 |

Additionally, in the optical system 1000 according to the second embodiment, a distance (first distance) between the first lens 110 and the second lens 120 may be as shown in Table 10 below.

TABLE 10

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | First distance | surface of the |
| first lens | (d12) (mm) | second lens |
| 0 | 0.2315 | 0 |
| 0.1 | 0.2314 | 0.1 |
| 0.2 | 0.2310 | 0.2 |
| 0.3 | 0.2304 | 0.3 |
| 0.4 | 0.2296 | 0.4 |
| 0.5 | 0.2287 | 0.5 |
| 0.6 | 0.2276 | 0.6 |
| 0.7 | 0.2265 | 0.7 |
| 0.8 | 0.2253 | 0.8 |
| 0.9 | 0.2242 | 0.9 |
| 1 | 0.2232 | 1 |
| 1.1 | 0.2223 | 1.1 |
| 1.2 | 0.2215 | 1.2 |
| 1.3(CP1) | 0.2210 | 1.3(CP1) |
| 1.4 | 0.2210 | 1.4 |
| 1.5 | 0.2221 | 1.5 |
| 1.6(CP2) | 0.2255 | 1.6(CP2) |

Referring to Table 10, the first distance may become smaller as it moves from the optical axis OA toward the first point CP1 located on the second surface S2. The first point CP1 may be disposed at a position that is about 40% to about 95% of the effective radius of the third surface S3 based on the optical axis OA. For example, in the second embodiment, the first point CP1 may be disposed at a position of about 81.3%. The first distance may increase from the first point CP1 to the second point CP2, which is the end of the effective diameter of the third surface S3. Here, a value represented by the second point CP2 is the effective radius value of the second surface S2 having a small effective diameter among the sensor-side surface (second surface S2) of the first lens 110 and the object-side surface (third surface S3) of the second lens 120 facing each other, and may mean ½ of the effective diameter of the second surface S2 shown in Table 8. The first distance may have a maximum value at the second point CP2 and a minimum value at the first point CP1. The maximum value of the first distance may be about 1.03 to about 1.5 times the minimum value. For example, in the second embodiment, the maximum value of the first distance may be about 1.05 times the minimum value. In the optical system 1000 according to the second embodiment, the first lens 110 and the second lens 120 may have the first distance that satisfies the above range depending on the regions. Accordingly, the optical system 1000 may have good optical performance by allowing light incident through the first lens 110 and the second lens 120 to move along a set path.

Additionally, in the optical system 1000 according to the second embodiment, a distance (second distance) between the fifth lens 150 and the sixth lens 160 may be as shown in Table 11 below.

TABLE 11

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the fifth | Second distance | surface of the sixth |
| lens | (d56) (mm) | lens |
| 0 | 0.2110 | 0 |
| 0.1 | 0.2105 | 0.1 |
| 0.2 | 0.2088 | 0.2 |
| 0.3 | 0.2061 | 0.3 |
| 0.4 | 0.2023 | 0.4 |
| 0.5 | 0.1976 | 0.5 |
| 0.6 | 0.1920 | 0.6 |
| 0.7 | 0.1856 | 0.7 |
| 0.8 | 0.1785 | 0.8 |
| 0.9 | 0.1709 | 0.9 |
| 1 | 0.1630 | 1 |
| 1.1 | 0.1550 | 1.1 |
| 1.2 | 0.1471 | 1.2 |
| 1.3 | 0.1395 | 1.3 |
| 1.4 | 0.1326 | 1.4 |
| 1.5 | 0.1267 | 1.5 |
| 1.6 | 0.1222 | 1.6 |
| 1.7(CP3) | 0.1198 | 1.7(CP3) |
| 1.8 | 0.1202 | 1.8 |
| 1.9 | 0.1245 | 1.9 |
| 1.978 (CP4) | 0.1337 | 1.978 (CP4) |

Referring to Table 11, the second distance may become smaller as it moves from the optical axis OA toward the third point CP3 located on the tenth surface S10. The third point CP3 may be disposed at a position that is about 70% to about 90% of the effective radius of the tenth surface S10 based on the optical axis OA. For example, in the second embodiment, the third point CP3 may be disposed at a position that is about 85.95% of the effective radius of the tenth surface S10. The second distance may become smaller as it goes from the third point CP3 to the third point CP3, which is the end of the effective diameter of the tenth surface S10. Here, a value represented by the fourth point CP4 is the effective radius value of the tenth surface S10 having a small effective diameter among the sensor-side surface (tenth surface S10) of the fifth lens 150 and the object-side surface (eleventh side S11) of the sixth lens 160 facing each other, and may mean ½ of the effective radius of the tenth surface S10 shown in Table 8. The second distance may have a maximum value at the third point CP3 and a minimum value at the optical axis OA. The maximum value of the second distance may be about 1.5 times to about 2 times the minimum value. For example, in the second embodiment, the maximum value of the second distance may be about 1.76 times the minimum value. In the optical system 1000 according to the second embodiment, the fifth lens 150 and the sixth lens 160 may have the second distance that satisfies the above range depending on the regions. Accordingly, the optical system 1000 may have improved aberration control characteristics and good optical performance in the peripheral portion of the FOV.

In the optical system 1000 according to the second embodiment, a distance (third distance) between the sixth lens 160 and the seventh lens 170 may be as shown in Table 12 below.

TABLE 12

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the sixth | Third distance | surface of the |
| lens | (d67) (mm) | seventh lens |
| 0 | 0.3138 | 0 |
| 0.1 | 0.3141 | 0.1 |
| 0.2 | 0.3152 | 0.2 |
| 0.3 | 0.3169 | 0.3 |
| 0.4 | 0.3193 | 0.4 |
| 0.5 | 0.3226 | 0.5 |
| 0.6 | 0.3267 | 0.6 |
| 0.7 | 0.3318 | 0.7 |
| 0.8 | 0.3379 | 0.8 |
| 0.9 | 0.3452 | 0.9 |
| 1 | 0.3536 | 1 |
| 1.1 | 0.3633 | 1.1 |
| 1.2 | 0.3741 | 1.2 |
| 1.3 | 0.3860 | 1.3 |
| 1.4 | 0.3988 | 1.4 |
| 1.5 | 0.4123 | 1.5 |
| 1.6 | 0.4260 | 1.6 |
| 1.7 | 0.4393 | 1.7 |
| 1.8 | 0.4515 | 1.8 |
| 1.9 | 0.4613 | 1.9 |
| 2 (CP5) | 0.4672 | 2 (CP5) |
| 2.1 | 0.4667 | 2.1 |
| 2.195(CP6) | 0.4560 | 2.195 (CP6) |

Referring to Table 12, the third distance may increase from the optical axis OA to the fifth point CP5 located on the twelfth surface S12. The fifth point CP5 may be disposed at a position that is about 80% to about 95% of the effective radius of the tenth surface S10 based on the optical axis OA. For example, in the second embodiment, the fifth point CP5 may be disposed at a position that is about 91.1% of the effective radius of the tenth surface S10. The third distance may become smaller from the fifth point CP5 to the sixth point CP6, which is the end of the effective diameter of the twelfth surface S12. Here, a value represented by the sixth point CP6 is the effective radius value of the twelfth surface S12 having a small effective diameter among the sensor-side surface (twelfth surface S12) of the sixth lens 160 and the object-side surface (thirteenth surface S13) of the seventh lens 170 facing each other, and may mean ½ of the effective diameter of the twelfth surface S12 shown in Table 8. The third distance may have a maximum value at the fifth point CP5 and a minimum value at the optical axis OA. The maximum value of the third distance may be about 1.2 times to about 2 times the minimum value. For example, in the second embodiment, the maximum value of the third distance may be about 1.49 times the minimum value. Accordingly, the optical system 1000 may have a slim structure by reducing the size of the effective diameter of the seventh lens 170, and the distortion characteristics of the optical system 1000 may be controlled. In the optical system 1000 according to the second embodiment, a distance (fourth distance) between the seventh lens 170 and the eighth lens 180 may be as shown in Table 13 below.

TABLE 13

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | Fourth distance | surface of the |
| seventh lens | (d78) (mm) | eighth lens |
| 0 | 0.1000 | 0 |
| 0.1 | 0.1015 | 0.1 |
| 0.2 | 0.1060 | 0.2 |
| 0.3 | 0.1134 | 0.3 |
| 0.4 | 0.1233 | 0.4 |
| 0.5 | 0.1356 | 0.5 |
| 0.6 | 0.1499 | 0.6 |
| 0.7 | 0.1657 | 0.7 |
| 0.8 | 0.1826 | 0.8 |
| 0.9 | 0.2002 | 0.9 |
| 1 | 0.2178 | 1 |
| 1.1 | 0.2350 | 1.1 |
| 1.2 | 0.2513 | 1.2 |
| 1.3 | 0.2662 | 1.3 |
| 1.4 | 0.2792 | 1.4 |
| 1.5 | 0.2900 | 1.5 |
| 1.6 | 0.2983 | 1.6 |
| 1.7 | 0.3038 | 1.7 |
| 1.8 (CP7) | 0.3065 | 1.8 (CP7) |
| 1.9 | 0.3064 | 1.9 |
| 2 | 0.3037 | 2 |
| 2.1 | 0.2988 | 2.1 |
| 2.2 | 0.2921 | 2.2 |
| 2.3 | 0.2842 | 2.3 |
| 2.4 | 0.2757 | 2.4 |
| 2.5 | 0.2675 | 2.5 |
| 2.62 (CP8) | 0.2606 | 2.62 (CP8) |

Referring to Table 13, the fourth distance may increase from the optical axis OA toward the seventh point CP7 located on the fourteenth surface S14. The seventh point CP7 may be disposed at a position that is about 60% to about 90% of the effective radius of the fourteenth surface S14 based on the optical axis OA. For example, in the second embodiment, the seventh point CP7 may be disposed at a position that is about 68.7% of the effective radius of the fourteenth surface S14. The fourth distance may become smaller from the seventh point CP7 toward the eighth point CP8, which is the end of the effective diameter of the fourteenth surface S14. Here, a value represented by the eighth point CP8 is the effective radius value of the fourteenth surface S14 having a small effective diameter among the sensor-side surface (fourteenth surface S14) of the seventh lens 170 and the object-side surface (fifteenth surface S15) of the eighth lens 180 facing each other, and may mean ½ of the effective diameter of the fourteenth surface S14 shown in Table 8. The fourth distance may have a maximum value at the seventh point CP7 and a minimum value at the optical axis OA. The maximum value of the fourth distance may be about 2.5 times to about 4.5 times the minimum value. For example, in the second embodiment, the maximum value of the fourth distance may be about 3.07 times the minimum value. In the optical system 1000 according to the second embodiment, the seventh lens 170 and the eighth lens 180 may have a fourth distance that satisfies the above range depending on the regions. Accordingly, the optical system 1000 may control the distortion characteristics of the optical system 1000 and have good optical performance in the center and periphery portions of the FOV. In addition, In the optical system 1000 according to the second embodiment, a distance (fifth distance) between the eighth lens 180 and the ninth lens 190 may be as shown in Table 14 below.

TABLE 14

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | Fifth distance | surface of the ninth |
| eighth lens | (d89) (mm) | lens |
| 0 | 0.4269 | 0 |
| 0.1 | 0.4266 | 0.1 |
| 0.2 | 0.4255 | 0.2 |
| 0.3 | 0.4235 | 0.3 |
| 0.4 | 0.4205 | 0.4 |
| 0.5 | 0.4161 | 0.5 |
| 0.6 | 0.4103 | 0.6 |
| 0.7 | 0.4028 | 0.7 |
| 0.8 | 0.3935 | 0.8 |
| 0.9 | 0.3825 | 0.9 |
| 1 | 0.3696 | 1 |
| 1.1 | 0.3547 | 1.1 |
| 1.2 | 0.3381 | 1.2 |
| 1.3 | 0.3196 | 1.3 |
| 1.4 | 0.2993 | 1.4 |
| 1.5 | 0.2775 | 1.5 |
| 1.6 | 0.2542 | 1.6 |
| 1.7 | 0.2296 | 1.7 |
| 1.8 | 0.2041 | 1.8 |
| 1.9 | 0.1780 | 1.9 |
| 2 | 0.1517 | 2 |
| 2.1 | 0.1258 | 2.1 |
| 2.2 | 0.1010 | 2.2 |
| 2.3 | 0.0780 | 2.3 |
| 2.4 | 0.0580 | 2.4 |
| 2.5 | 0.0420 | 2.5 |
| 2.6 | 0.0315 | 2.6 |
| 2.7 (CP10) | 0.0281 | 2.7 (CP10) |
| 2.8 | 0.0336 | 2.8 |
| 2.9 | 0.0500 | 2.9 |
| 3 | 0.0796 | 3 |
| 3.1 | 0.1247 | 3.1 |
| 3.2 | 0.1881 | 3.2 |
| 3.29 (CP11) | 0.2722 | 3.29 (CP11) |

Referring to Table 14, the fifth distance may become smaller as it moves from the optical axis OA toward the tenth point CP10 located on the sixteenth surface S16. The tenth point CP10 may be disposed at a position that is about 70% to about 90% of the effective radius of the sixteenth surface S16 based on the optical axis OA. For example, in the second embodiment, the tenth point CP10 may be disposed at a position that is about 82.1% of the effective radius of the sixteenth surface S16. The fourth distance may increase from the ninth point CP9 toward the eleventh point CP11, which is the end of the effective diameter of the sixteenth surface S16. Here, a value represented by the eleventh point CP11 is the effective radius value of the sixteenth surface S16 having a small effective diameter among the sensor-side surface (sixteenth surface S16) of the eighth lens 180 and the object-side surface (seventeenth surface) of the ninth lens 190 facing each other, and may mean ½ of the effective diameter of the sixteenth surface S16 shown in Table 8. The fifth distance may have a maximum value at the optical axis OA and a minimum value at the tenth point CP10. The maximum value of the fifth distance may be about 10 to about 20 times the minimum value. For example, in the second embodiment, the maximum value of the fifth distance may be about 15.2 times the minimum value. In the optical system 1000 according to the second embodiment, the eighth lens 180 and the ninth lens 190 may have the fifth distance that satisfies the above range depending on the area. Accordingly, the optical system 1000 may have improved chromatic aberration and distortion aberration control characteristics, and may have good optical performance in the center and periphery portions of the FOV. FIG. 6 is a graph of MTF versus spatial frequency of the optical system 1000 according to the second embodiment, FIG. 7 is a graph for the diffraction MTF of the optical system according to the second embodiment, and FIG. 8 is an aberration graph of the optical system according to the second embodiment. FIG. 6 measures the MTF characteristics according to the spatial frequency, and when the MTF value is 1, it means that it has the best resolution, and when the MTF value decreases from 1, it means that the resolution decreases.

The aberration graph in FIG. 8 is a graph measuring spherical aberration, astigmatic field curves, and distortion from left to right. In FIG. 8, the X-axis may represent focal length (mm) and distortion aberration (%), and the Y-axis may represent the height of the image. Additionally, the graphs for spherical aberration, astigmatism, and distortion aberration are graphs for light in wavelength bands of about 486 nm, about 587 nm, and about 656 nm. In the aberration diagram of FIG. 8, it may be interpreted that the closer each curve is to the Y-axis, the better the aberration correction function, and referring to FIG. 8, it may be seen that measurement values of the optical system 1000 according to the embodiment are adjacent to the Y-axis in most regions. That is, the optical system 1000 according to the second embodiment has improved resolution and may have good optical performance in the center and periphery portions of the FOV.

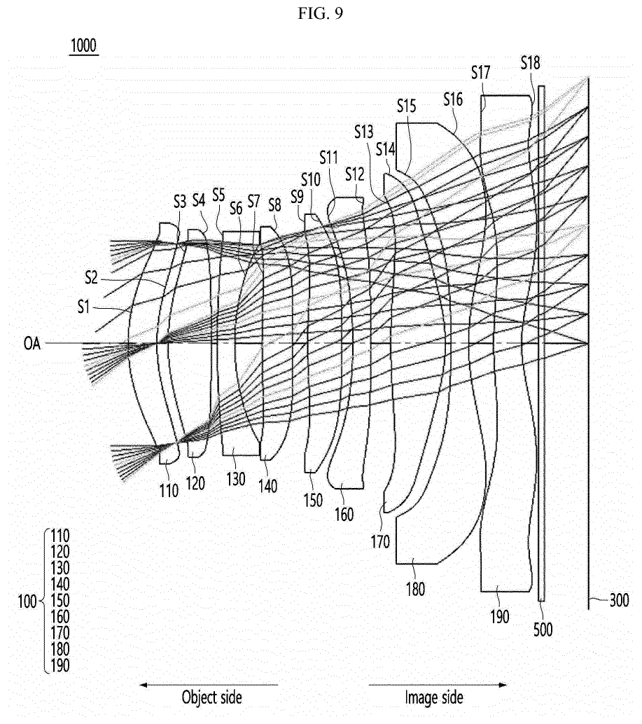

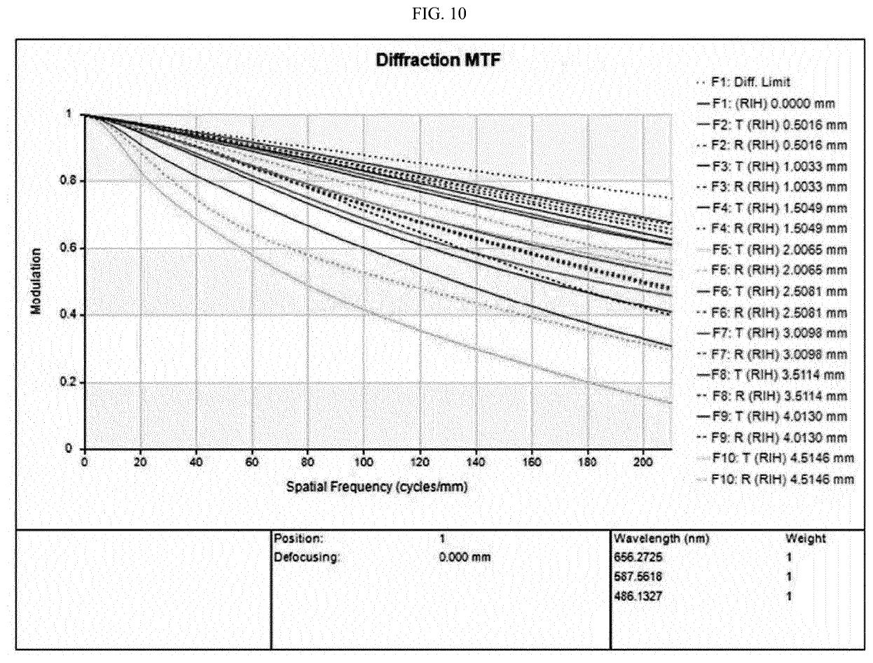

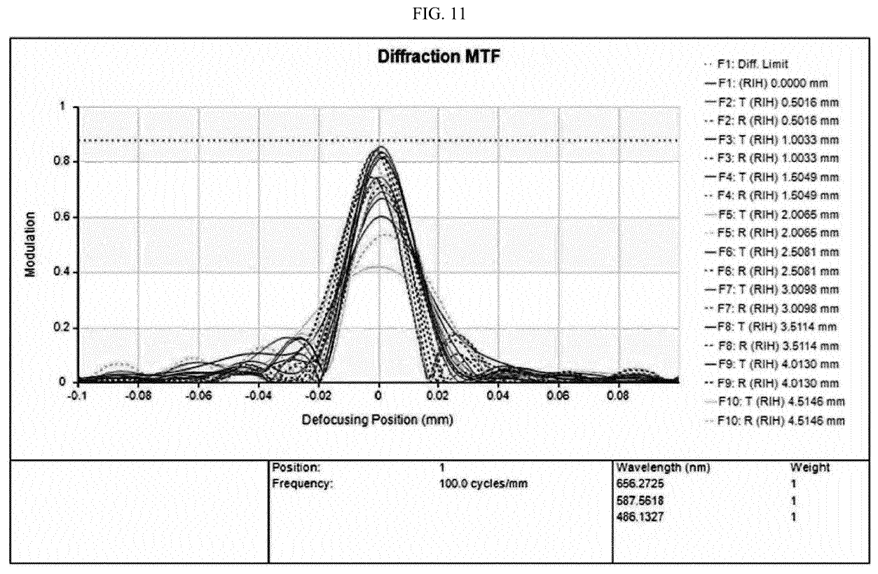

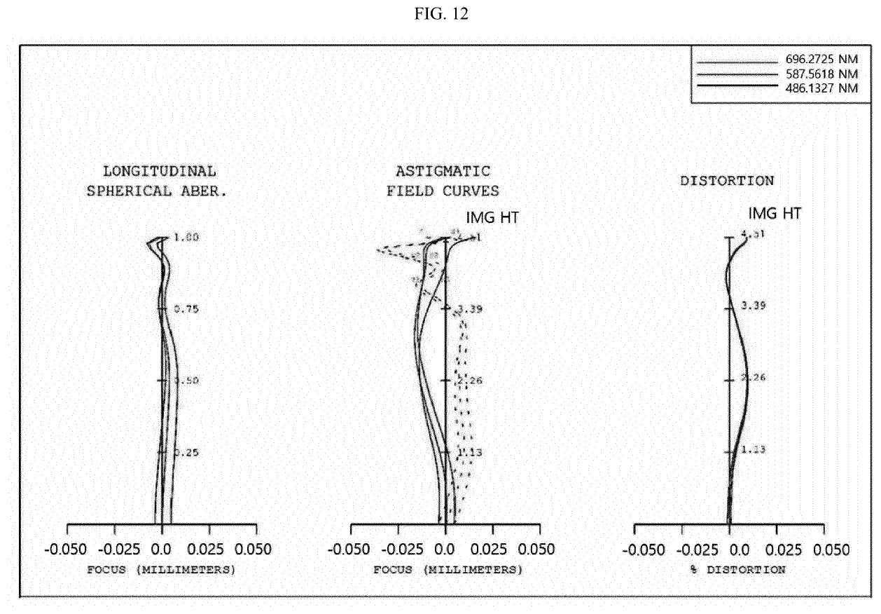

FIG. 9 is a configuration diagram of an optical system according to the third embodiment. In addition, FIG. 10 is a graph of the MTF of the spatial frequency of the optical system according to the third embodiment, FIG. 11 is a graph of the diffraction MTF of the optical system according to the third embodiment, and FIG. 12 is an aberration graph of the MTF of the optical system according to the third embodiment. Referring to FIGS. 9 to 11, the optical system 1000 according to the third embodiment includes a first lens 110, a second lens 120, a third lens 130, a fourth lens 140, a fifth lens 150, a sixth lens 160, a seventh lens 170, an eighth lens 180, a ninth lens 190, and an image sensor 300. The first to ninth lenses 110, 120, 130, 140, 150, 160, 170, 180, and 190 may be sequentially arranged along the optical axis OA of the optical system 1000.

In the optical system 1000 according to the third embodiment, an aperture stop may be disposed between the first lens 110 and the second lens 120. The sensor-side surface (second surface S2) of the first lens 110 may function as an aperture stop. A filter 500 may be disposed between the plurality of lenses 100 and the image sensor 300. In detail, the filter 500 may be disposed between the ninth lens 190 and the image sensor 300.

TABLE 15

| | | Radius of | Thickness (mm)/ | Reflective | Abbe | Effective |
|---|---|---|---|---|---|---|
| Lens | Surface | curvature (mm) | Distance (mm) | Index | number | diameter (mm) |
| Lens 1 | S1 | 2.823 | 0.491 | 1.564 | 62.25 | 3.707 |
| | S2 | 2.881 | 0.188 | | | 3.400 |
| | (Stop) | | | | | |
| Lens 2 | S3 | 3.183 | 0.739 | 1.606 | 60.37 | 3.472 |
| | S4 | −77.842 | 0.100 | | | 3.499 |
| Lens 3 | S5 | 13.055 | 0.300 | 1.755 | 27.57 | 3.441 |
| | S6 | 3.626 | 0.467 | | | 3.327 |
| Lens 4 | S7 | 15.390 | 0.527 | 1.626 | 44.85 | 3.348 |
| | S8 | 142.267 | 0.256 | | | 3.590 |
| Lens 5 | S9 | 9.803 | 0.582 | 1.635 | 44.85 | 3.781 |
| | S10 | −33.831 | 0.187 | | | 3.970 |
| Lens 6 | S11 | −7.416 | 0.300 | 1.727 | 27.57 | 4.000 |
| | S12 | 116.364 | 0.351 | | | 4.482 |
| Lens 7 | S13 | 11.919 | 0.927 | 1.627 | 45.31 | 5.014 |
| | S14 | −2.793 | 0.100 | | | 5.427 |
| Lens 8 | S15 | −13.670 | 0.300 | 1.581 | 50.49 | 5.583 |
| | S16 | 3.822 | 0.427 | | | 6.782 |
| Lens 9 | S17 | 5.676 | 0.477 | 1.741 | 32.48 | 7.163 |
| | S18 | 2.402 | 0.286 | | | 7.636 |
| Filter | | Infinity | 0.110 | | | 7.818 |
| | | Infinity | 0.750 | | | 7.912 |
| Image | | Infinity | 0.000 | | | 9.030 |
| sensor | | | | | | |

Table 15 shows the radius of curvature on the optical axis OA of the first to ninth lenses 110, 120, 130, 140, 140, 150, 160, 170, 180, and 190 according to a third embodiment, the thickness of the lens, the distance between the lenses, the refractive index, Abbe Number, and the size of the effective diameter (CA: clear aperture). The first lens 110 of the optical system 1000 according to the third embodiment may have positive (+) refractive power on the optical axis OA. The first surface S1 of the first lens 110 may have a convex shape on the optical axis OA, and the second surface S2 may have a concave shape on the optical axis OA. The first lens 110 may have a meniscus shape that is convex on the optical axis OA toward the object. The first surface S1 and the second surface S2 may have aspheric coefficients as shown in Table 16 below. The second lens 120 may have positive (+) refractive power on the optical axis OA. The third surface S3 of the second lens 120 may have a convex shape on the optical axis OA, and the fourth surface S4 may have a convex shape on the optical axis OA. The second lens 120 may have a shape in which both sides are convex on the optical axis OA. The third surface S3 may be an aspherical surface, and the fourth surface S4 may be an aspherical surface. The third surface S3 and the fourth surface S4 may have aspheric coefficients as shown in Table 16 below. The third lens 130 may have negative refractive power on the optical axis OA. The fifth surface S5 of the third lens 130 may have a convex shape on the optical axis OA, and the sixth surface S6 may have a concave shape on the optical axis OA. The third lens 130 may have a meniscus shape that is convex on the optical axis OA toward the object. The fifth surface S5 may be an aspherical surface, and the sixth surface S6 may be an aspherical surface. The fifth surface S5 and the sixth surface S6 may have aspherical coefficients as shown in Table 16 below.

The fourth lens 140 may have positive (+) refractive power on the optical axis OA. The seventh surface S7 of the fourth lens 140 may have a convex shape on the optical axis OA, and the eighth surface S8 may have a concave shape on the optical axis OA. The fourth lens 140 may have a meniscus shape that is convex on the optical axis OA toward the object. The seventh surface S7 may be an aspherical surface, and the eighth surface S8 may be an aspherical surface. The seventh surface S7 and the eighth surface S8 may have aspheric coefficients as shown in Table 16 below. The fifth lens 150 may have positive (+) refractive power on the optical axis OA. The ninth surface S9 of the fifth lens 150 may have a convex shape on the optical axis OA, and the tenth surface S10 may have a convex shape on the optical axis OA. The fifth lens 150 may have a shape in which both sides are convex on the optical axis OA. The ninth surface S9 may be an aspherical surface, and the tenth surface S10 may be an aspherical surface. The ninth surface S9 and the tenth surface S10 may have aspheric coefficients as shown in Table 16 below. The sixth lens 160 may have negative refractive power on the optical axis OA. The eleventh surface S11 of the sixth lens 160 may have a concave shape on the optical axis OA, and the twelfth surface S12 may have a concave shape on the optical axis OA. The sixth lens 160 may have a shape in which both sides are concave of the optical axis OA. The eleventh surface S11 may be an aspherical surface, and the twelfth surface S12 may be an aspherical surface. The eleventh surface S11 and the twelfth surface S12 may have aspherical coefficients as shown in Table 16 below.

The seventh lens 170 may have positive (+) refractive power on the optical axis OA. The thirteenth surface S13 of the seventh lens 170 may have a convex shape on the optical axis OA, and the fourteenth surface S14 may have a convex shape on the optical axis OA. The seventh lens 170 may have a shape in which both sides are convex on the optical axis OA. The thirteenth surface S13 may be an aspherical surface, and the fourteenth surface S14 may be an aspherical surface. The thirteenth surface S13 and the fourteenth surface S14 may have aspheric coefficients as shown in Table 16 below. The eighth lens 180 may have negative refractive power on the optical axis OA. The fifteenth surface S15 of the eighth lens 180 may have a concave shape on the optical axis OA, and the sixteenth surface S16 may have a concave shape on the optical axis OA. The eighth lens 180 may have a shape in which both sides are concave of the optical axis OA. The fifteenth surface S15 may be an aspherical surface, and the sixteenth surface S16 may be an aspherical surface. The fifteenth surface S15 and the sixteenth surface S16 may have aspheric coefficients as shown in Table 16 below.

The eighth lens 180 may include an inflection point. In detail, the above-described first inflection point may be disposed on the sixteenth surface S16 of the eighth lens 180. The first inflection point may be disposed at a position that is about 40% to about 85% of the effective radius of the sixteenth surface S16 of the eighth lens 180 with respect to the optical axis OA. In the optical system according to the third embodiment, the first inflection point may be located at a position that is about 67% of the effective radius of the sixteenth surface S16. The ninth lens 190 may have negative refractive power on the optical axis OA. The seventeenth surface S17 of the ninth lens 190 may have a convex shape on the optical axis OA, and the eighteenth surface S18 may have a concave shape on the optical axis OA. The ninth lens 190 may have a meniscus shape convex on the optical axis OA toward the object. The seventeenth surface S17 may be an aspherical surface, and the eighteenth surface S18 may be an aspherical surface. The seventeenth surface S17 and the eighteenth surface S18 may have aspheric coefficients as shown in Table 16 below.

The ninth lens 190 may include an inflection point. In detail, the above-described second inflection point may be disposed on the seventeenth surface S17 of the ninth lens 190. The second inflection point may be disposed at a position of about 15% to about 60% when the optical axis OA is a starting point and an end of the effective region of the seventeenth surface S17 of the ninth lens 190 is an end point. In the optical system according to the third embodiment, the second inflection point may be disposed at a position that is about 37% when the optical axis OA is starting point and set as a starting point and an end of the effective region of the seventeenth surface S17 of the ninth lens 190 is an end point. The third inflection point described above may be disposed on the eighteenth surface S18 of the ninth lens 190. The third inflection point may be disposed at a position that is about 30% to about 80% of the effective radius of the eighteenth surface S18 of the ninth lens 190 with respect to the optical axis OA. In the optical system according to the third embodiment, the third inflection point may be located at a position that is about 50% of the effective radius of the eighteenth surface S18 of the ninth lens 190.

In the third embodiment, an inflection point defined as a fourth inflection point may be further disposed on the eighteenth surface S18 of the ninth lens 190. The fourth inflection point may be disposed at a greater distance from the optical axis OA than the third inflection point. The fourth inflection point may be disposed at a position that is about 60% to about 90% of the effective radius of the eighteenth surface S18 of the ninth lens 190 with respect to the optical axis OA. In the optical system according to the third embodiment, the fourth inflection point may be located at a position that is about 74% of the effective radius of the eighteenth surface S18.

In the optical system 1000 according to the third embodiment, the plurality of lenses 100 may include a plurality of lens groups. For example, the plurality of lenses 100 may include a first lens group G1 disposed between the object and the aperture stop and a second lens group G2 disposed between the aperture stop and the image sensor 300. That is, the first lens group G1 may include the first lens 110, and the second lens group G2 may include the second to ninth lenses 120, 130, 140, 150, 160, 170, 180, and 190. At this time, each of the composite focal length of the first lens group G1 and the composite focal length of the second lens group G2 may have a positive value. Accordingly, the optical system 1000 according to the third embodiment may have improved distortion aberration control characteristics.

The aspheric coefficient values of each lens surface in the optical system 1000 according to the third embodiment are shown in Table 16 below.

TABLE 16

| | L1 | | L2 | | L3 | | L4 | | L5 |
|---|---|---|---|---|---|---|---|---|---|
| | S1 | S2 | S3 | S4 | S5 | S6 | S7 | S8 | S9 |
| R | 2.823 | 2.881 | 3.183 | −77.842 | 13.055 | 3.626 | 15.390 | 142.267 | 9.803 |
| K | −1.253 | −2.819 | −0.386 | 11.508 | −100.000 | −2.310 | 22.038 | −100.000 | −11.345 |
| A | −1.13E−03 | −8.18E−03 | −1.45E−02 | −2.24E−03 | −1.13E−03 | −3.57E−04 | −6.33E−03 | −1.70E−02 | −1.93E−02 |
| B | 6.51E−04 | −7.90E−04 | −1.75E−03 | −2.47E−03 | 5.60E−04 | 2.51E−03 | −3.64E−03 | −1.80E−03 | 2.69E−04 |
| C | −6.77E−04 | −3.79E−05 | 3.36E−04 | −2.55E−04 | −4.06E−04 | −9.97E−05 | 2.25E−04 | −1.59E−04 | 2.89E−05 |
| D | 1.21E−04 | −1.11E−04 | −1.05E−04 | 5.66E−05 | 1.74E−04 | 4.59E−05 | −7.19E−05 | −1.28E−05 | 2.97E−05 |
| E | −5.26E−06 | −1.35E−04 | −1.44E−04 | 7.83E−06 | 8.69E−06 | 1.38E−05 | 1.50E−06 | 1.21E−05 | −6.21E−06 |
| F | −2.64E−06 | 8.07E−05 | 2.59E−05 | 2.02E−05 | 1.24E−05 | 2.06E−06 | 8.78E−06 | 1.13E−06 | 1.64E−07 |
| G | −1.21E−05 | −1.69E−06 | 3.22E−05 | 3.92E−06 | −3.22E−06 | −1.20E−06 | −4.86E−07 | 2.19E−07 | 2.58E−08 |
| H | 6.08E−06 | −6.63E−07 | −3.06E−06 | −4.79E−07 | −1.46E−06 | −7.95E−07 | −2.49E−07 | −5.51E−08 | 1.64E−08 |
| J | −7.97E−07 | −4.54E−07 | −1.27E−06 | −6.76E−07 | 1.47E−07 | 1.90E−07 | −6.95E−08 | −5.64E−08 | −4.39E−09 |
| | L5 | L6 | | L7 | | L8 | | L9 | |
| | S10 | S11 | S12 | S13 | S14 | S15 | S16 | S17 | S18 |
| R | −33.831 | −7.416 | 116.364 | 11.919 | −2.793 | −13.670 | 3.822 | 5.676 | 2.402 |
| K | 100.000 | −14.851 | 100.000 | −32.564 | −6.208 | −29.578 | −5.046 | −64.282 | −10.542 |
| A | −1.47E−02 | −1.37E−02 | −1.00E−02 | 4.27E−04 | 8.70E−03 | −5.10E−03 | −7.27E−03 | −1.22E−02 | −1.57E−02 |
| B | −2.05E−03 | 4.67E−04 | −1.39E−03 | −2.43E−03 | −1.27E−03 | −2.39E−03 | −9.71E−04 | −1.61E−04 | 1.10E−03 |
| C | 7.97E−04 | −1.06E−06 | 9.12E−04 | 3.95E−04 | −3.79E−06 | 5.30E−04 | 2.17E−04 | 1.84E−04 | −2.90E−05 |
| D | −1.61E−04 | 3.78E−05 | −1.61E−04 | −4.68E−05 | 2.26E−05 | −3.62E−05 | −1.95E−05 | −1.33E−05 | 1.06E−06 |
| E | 1.80E−05 | −3.86E−06 | 1.65E−05 | 3.28E−06 | −2.54E−06 | 2.35E−06 | 7.59E−07 | 3.91E−07 | −2.50E−08 |
| F | −1.09E−06 | 2.75E−07 | −8.90E−07 | −3.95E−07 | 6.39E−08 | −1.52E−07 | −1.57E−08 | −6.12E−09 | 2.62E−11 |
| G | −2.92E−08 | 3.55E−08 | 1.44E−08 | 3.54E−09 | −3.60E−09 | −9.61E−09 | 6.47E−10 | 1.35E−11 | −2.50E−11 |
| H | −3.93E−09 | 1.13E−08 | 3.95E−10 | 1.33E−09 | −3.98E−10 | −1.08E−09 | −5.69E−12 | 4.62E−13 | −7.69E−13 |
| J | 4.75E−09 | 4.15E−10 | 8.37E−10 | 2.59E−10 | −7.69E−11 | 6.81E−11 | −1.22E−12 | 1.59E−14 | −3.25E−14 |

Additionally, in the optical system 1000 according to the third embodiment, a distance (first distance) between the first lens 110 and the second lens 120 may be as shown in Table 17 below.

TABLE 17

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the first | First distance | surface of the |
| lens | (d12) (mm) | second lens |
| 0 | 0.1879 | 0 |
| 0.1 | 0.1877 | 0.1 |
| 0.2 | 0.1873 | 0.2 |
| 0.3 | 0.1865 | 0.3 |
| 0.4 | 0.1854 | 0.4 |
| 0.5 | 0.1841 | 0.5 |
| 0.6 | 0.1826 | 0.6 |
| 0.7 | 0.1810 | 0.7 |
| 0.8 | 0.1792 | 0.8 |
| 0.9 | 0.1774 | 0.9 |
| 1 | 0.1755 | 1 |
| 1.1 | 0.1737 | 1.1 |
| 1.2 | 0.1719 | 1.2 |
| 1.3 | 0.1702 | 1.3 |
| 1.4 | 0.1689 | 1.4 |
| 1.5 (CP1) | 0.1686 | 1.5 (CP1) |
| 1.6 | 0.1704 | 1.6 |
| 1.7 (CP2) | 0.1750 | 1.7 (CP2) |

Referring to Table 17, the first distance may become smaller as it moves from the optical axis OA to the first point CP1 located on the second surface S2. The first point CP1 may be disposed at a position that is about 40% to about 95% of the effective radius of the third surface S3 based on the optical axis OA. For example, in the third embodiment, the first point CP1 may be placed at a position that is about 88.2% of the effective radius of the third surface S3. The first distance may increase from the first point CP1 to the second point CP2, which is the end of the effective diameter of the third surface S3. Here, a value represented by the second point CP2 is the effective radius value of the second surface S2 having a small effective diameter among the sensor-side surface (second surface S2) of the first lens 110 and the object-side surface (third surface S3) of the second lens 120 facing each other, and may mean ½ of the effective diameter of the second surface S2 shown in Table 15. The first distance may have a maximum value at the second point CP2 and a minimum value at the first point CP1. The maximum value of the first distance may be about 1.03 to about 1.5 times the minimum value. For example, in the third embodiment, the maximum value of the first distance may be about 1.11 times the minimum value. In the optical system 1000 according to the third embodiment, the first lens 110 and the second lens 120 may have the first distance that satisfies the above range depending on the regions. Accordingly, the optical system 1000 may have good optical performance by allowing light incident through the first lens 110 and the second lens 120 to move along a set path. In the optical system 1000 according to the third embodiment, a distance (second distance) between the fifth lens 150 and the sixth lens 160 may be as shown in Table 18 below.

TABLE 18

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the fifth | Second distance | surface of the sixth |
| lens | (d56) (mm) | lens |
| 0 | 0.1867 | 0 |
| 0.1 | 0.1862 | 0.1 |
| 0.2 | 0.1846 | 0.2 |
| 0.3 | 0.1820 | 0.3 |
| 0.4 | 0.1784 | 0.4 |
| 0.5 | 0.1739 | 0.5 |
| 0.6 | 0.1686 | 0.6 |
| 0.7 | 0.1624 | 0.7 |
| 0.8 | 0.1557 | 0.8 |
| 0.9 | 0.1486 | 0.9 |
| 1 | 0.1411 | 1 |
| 1.1 | 0.1337 | 1.1 |
| 1.2 | 0.1265 | 1.2 |
| 1.3 | 0.1198 | 1.3 |
| 1.4 | 0.1141 | 1.4 |
| 1.5 | 0.1098 | 1.5 |
| 1.6 (CP3) | 0.1075 | 1.6 (CP3) |
| 1.7 | 0.1082 | 1.7 |
| 1.8 | 0.1130 | 1.8 |
| 1.9 | 0.1237 | 1.9 |
| 1.985 (CP4) | 0.1428 | 1.985 (CP4) |

Referring to Table 18, the second distance may become smaller as it moves from the optical axis OA toward the third point CP3 located on the tenth surface S10. The third point CP3 may be disposed at a position that is about 70% to about 90% of the effective radius of the tenth surface S10 based on the optical axis OA. For example, in the third embodiment, the third point CP3 may be disposed at a position that is about 80.6% of the effective radius of the tenth surface S10. The second distance may become smaller as it goes from the third point CP3 toward the third point CP3, which is the end of the effective diameter of the tenth surface S10. Here, the value signified by the fourth point is the effective radius value of the tenth surface S10 having a small effective diameter among the sensor-side surface (tenth surface S10) of the fifth lens 150 and the object-side surface (eleventh side S11) of the sixth lens 160 facing each other, and may mean ½ of the effective radius of the tenth surface S10 shown in Table 15. The second distance may have a maximum value at the third point CP3 and a minimum value at the optical axis OA. The maximum value of the second distance may be about 1.5 times to about 2 times the minimum value. For example, in the third embodiment, the maximum value of the second distance may be about 1.74 times the minimum value. In the optical system 1000 according to the third embodiment, the fifth lens 150 and the sixth lens 160 may have the second distance that satisfies the above range depending on the area. Accordingly, the optical system 1000 may have improved aberration control characteristics and good optical performance in the peripheral portion of the FOV.

In the optical system 1000 according to the third embodiment, a distance (third distance) between the sixth lens 160 and the seventh lens 170 may be as shown in Table 19 below.

TABLE 19

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the sixth | Third distance | surface of the |
| lens | (d67) (mm) | seventh lens |
| 0 | 0.3510 | 0 |
| 0.1 | 0.3513 | 0.1 |
| 0.2 | 0.3525 | 0.2 |
| 0.3 | 0.3544 | 0.3 |
| 0.4 | 0.3572 | 0.4 |
| 0.5 | 0.3609 | 0.5 |
| 0.6 | 0.3655 | 0.6 |
| 0.7 | 0.3712 | 0.7 |
| 0.8 | 0.3781 | 0.8 |
| 0.9 | 0.3862 | 0.9 |
| 1 | 0.3955 | 1 |
| 1.1 | 0.4061 | 1.1 |
| 1.2 | 0.4179 | 1.2 |
| 1.3 | 0.4308 | 1.3 |
| 1.4 | 0.4446 | 1.4 |
| 1.5 | 0.4589 | 1.5 |
| 1.6 | 0.4732 | 1.6 |
| 1.7 | 0.4868 | 1.7 |
| 1.8 | 0.4988 | 1.8 |
| 1.9 | 0.5080 | 1.9 |
| 2 (CP5) | 0.5126 | 2 (CP5) |
| 2.1 | 0.5100 | 2.1 |
| 2.2 | 0.4966 | 2.2 |
| 2.241 (CP6) | 0.4666 | 2.241 (CP6) |

Referring to Table 19, the third distance may increase from the optical axis OA toward the fifth point CP5 located on the twelfth surface S12. The fifth point CP5 may be disposed at a position that is about 80% to about 95% of the effective radius of the tenth surface S10 based on the optical axis OA. For example, in the third embodiment, the fifth point CP5 may be placed at a position of about 89.3%. The third distance may become smaller from the fifth point CP5 toward the sixth point CP6, which is the end of the effective diameter of the twelfth surface S12. Here, a value represented by the sixth point is the effective radius value of the twelfth surface S12 having a small effective diameter among the sensor-side surface (twelfth surface S12) of the sixth lens 160 and the object-side surface (thirteenth surface S13) of the seventh lens 170 facing each other, and may mean ½ of the effective diameter of the twelfth surface S12 shown in Table 15. The third distance may have a maximum value at the fifth point CP5 and a minimum value at the optical axis OA. The maximum value of the third distance may be about 1.2 times to about 2 times the minimum value. For example, in the third embodiment, the maximum value of the third distance may be about 1.46 times the minimum value. Accordingly, the optical system 1000 may have improved aberration control characteristics and may have good optical performance at the periphery portion of the FOV.

In the optical system 1000 according to the third embodiment, a distance (fourth distance) between the seventh lens 170 and the eighth lens 180 may be as shown in Table 20 below.

TABLE 20

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | Fourth distance | surface of the |
| seventh lens | (d78) (mm) | eighth lens |
| 0 | 0.1000 | 0 |
| 0.1 | 0.1014 | 0.1 |
| 0.2 | 0.1056 | 0.2 |
| 0.3 | 0.1125 | 0.3 |
| 0.4 | 0.1217 | 0.4 |
| 0.5 | 0.1331 | 0.5 |
| 0.6 | 0.1462 | 0.6 |
| 0.7 | 0.1605 | 0.7 |
| 0.8 | 0.1757 | 0.8 |
| 0.9 | 0.1912 | 0.9 |
| 1 | 0.2065 | 1 |
| 1.1 | 0.2212 | 1.1 |
| 1.2 | 0.2347 | 1.2 |
| 1.3 | 0.2467 | 1.3 |
| 1.4 | 0.2565 | 1.4 |
| 1.5 | 0.2641 | 1.5 |
| 1.6 | 0.2690 | 1.6 |
| 1.7 (CP7) | 0.2711 | 1.7 (CP7) |
| 1.8 | 0.2706 | 1.8 |
| 1.9 | 0.2676 | 1.9 |
| 2 | 0.2625 | 2 |
| 2.1 | 0.2559 | 2.1 |
| 2.2 | 0.2488 | 2.2 |
| 2.3 | 0.2422 | 2.3 |
| 2.4 | 0.2373 | 2.4 |
| 2.5 (CP8) | 0.2357 | 2.5 (CP8) |
| 2.6 | 0.2389 | 2.6 |
| 2.714 (CP9) | 0.2492 | 2.714 (CP9) |

Referring to Table 20, the fourth distance may increase from the optical axis OA toward the seventh point CP7 located on the fourteenth surface S14. The seventh point CP7 may be disposed at a position that is about 50% to about 70% of the effective radius of the fourteenth surface S14 based on the optical axis OA. For example, in the third embodiment, the seventh point CP7 may be disposed at a position of about 62.6%. The fourth distance may increase from the optical axis OA toward the eighth point CP8 located on the fourteenth surface S14. The eighth point CP8 may be located at a greater distance from the optical axis OA than the seventh point CP7. The eighth point CP8 may be disposed at a position that is about 80% to about 95% of the effective radius of the sixteenth surface S16 based on the optical axis OA. For example, in the third embodiment, the eighth point CP8 may be placed at a position that is about 92.1% of the effective radius of the sixteenth surface S16. The fourth distance may become smaller from the eighth point CP8 toward ninth point CP9, which is the end of the effective diameter of the fourteenth surface S14. Here, a value represented by the ninth point CP9 is the effective radius value of the fourteenth surface S14 having a small effective diameter among the sensor-side surface (fourteenth surface S14) of the seventh lens 170 and the object-side surface (fifteenth surface S15) of the eighth lens 180 facing each other, and may mean ½ of the effective diameter of the fourteenth surface S14 shown in Table 15. The fourth distance may have a maximum value at the seventh point CP7 and a minimum value at the optical axis OA. The maximum value of the fourth distance may be about 2.5 times to about 4.5 times the minimum value. For example, in the third embodiment, the maximum value of the fourth distance may be about 2.71 times the minimum value. In the optical system 1000 according to the third embodiment, the seventh lens 170 and the eighth lens 180 may have the fourth distance that satisfies the above range depending on the area. Accordingly, the optical system 1000 can control the distortion characteristics of the optical system 1000 and have good optical performance in the center and periphery portions of the FOV.

In the optical system 1000 according to the third embodiment, a distance (fifth distance) between the eighth lens 180 and the ninth lens 190 may be as shown in Table 21 below.

TABLE 21

| Height (mm) in the | | Height (mm) in the |
|---|---|---|
| vertical direction | | vertical direction |
| of the optical axis | | of the optical axis |
| from the optical axis | | from the optical axis |
| on the sensor-side | | on the object-side |
| surface of the | Fifth distance | surface of the ninth |
| eighth lens | (d89) (mm) | lens |
| 0 | 0.4271 | 0 |
| 0.1 | 0.4267 | 0.1 |
| 0.2 | 0.4253 | 0.2 |
| 0.3 | 0.4230 | 0.3 |
| 0.4 | 0.4194 | 0.4 |
| 0.5 | 0.4145 | 0.5 |
| 0.6 | 0.4080 | 0.6 |
| 0.7 | 0.3999 | 0.7 |
| 0.8 | 0.3900 | 0.8 |
| 0.9 | 0.3784 | 0.9 |
| 1 | 0.3649 | 1 |
| 1.1 | 0.3495 | 1.1 |
| 1.2 | 0.3324 | 1.2 |
| 1.3 | 0.3135 | 1.3 |
| 1.4 | 0.2931 | 1.4 |
| 1.5 | 0.2711 | 1.5 |
| 1.6 | 0.2478 | 1.6 |
| 1.7 | 0.2234 | 1.7 |
| 1.8 | 0.1982 | 1.8 |
| 1.9 | 0.1726 | 1.9 |
| 2 | 0.1470 | 2 |
| 2.1 | 0.1219 | 2.1 |
| 2.2 | 0.0980 | 2.2 |
| 2.3 | 0.0760 | 2.3 |
| 2.4 | 0.0570 | 2.4 |
| 2.5 | 0.0419 | 2.5 |
| 2.6 | 0.0320 | 2.6 |
| 2.7 (CP10) | 0.0287 | 2.7 (CP10) |
| 2.8 | 0.0334 | 2.8 |
| 2.9 | 0.0478 | 2.9 |
| 3 | 0.0735 | 3 |
| 3.1 | 0.1122 | 3.1 |
| 3.2 | 0.1653 | 3.2 |
| 3.3 | 0.2345 | 3.3 |
| 3.391 (CP11) | 0.3210 | 3.391 (CP11) |

Referring to Table 21, the fifth distance may become smaller as it moves from the optical axis OA toward the tenth point CP10 located on the sixteenth surface S16. The tenth point CP10 may be disposed at a position that is about 70% to about 90% of the effective radius of the sixteenth surface S16 based on the optical axis OA. For example, in the third embodiment, the tenth point CP10 may be disposed at a position that is about 79.6% of the effective radius of the sixteenth surface S16. The fifth distance may increase from the tenth point CP10 toward the eleventh point CP11, which is the end of the effective diameter of the sixteenth surface S16. Here, a value represented by the eleventh point CP11 is the effective radius value of the sixteenth surface S16 having a small effective diameter among the sensor-side surface (sixteenth surface S16) of the eighth lens 180 and the object-side surface (seventeenth surface) of the ninth lens 190 facing each other, and may mean ½ of the effective diameter of the sixteenth surface S16 shown in Table 15. The fifth distance may have a maximum value at the optical axis OA and a minimum value at the tenth point CP10. The maximum value of the fifth distance may be about 10 to about 20 times the minimum value. For example, in the third embodiment, the maximum value of the fifth distance may be about 14.9 times the minimum value. In the optical system 1000 according to the third embodiment, the eighth lens 180 and the ninth lens 190 may have a fifth distance that satisfies the above range depending on the regions. Accordingly, the optical system 1000 may have improved chromatic aberration and distortion aberration control characteristics, and may have good optical performance in the center and periphery portions of the FOV. FIG. 10 is a graph of MTF versus spatial frequency of the optical system 1000 according to the third embodiment, FIG. 11 is a graph for the diffraction MTF of the optical system according to the third embodiment, and FIG. 12 is an aberration graph of the optical system according to the third embodiment. FIG. 10 measures the MTF characteristics according to the spatial frequency, and when the MTF value is 1, it means that it has the best resolution, and when the MTF value decreases from 1, it means that the resolution decreases.

The aberration graph in FIG. 12 is a graph measuring spherical aberration, astigmatic field curves, and distortion from left to right. In FIG. 12, the X-axis may represent focal length (mm) and distortion aberration (%), and the Y-axis may represent the height of the image. Additionally, the graphs for spherical aberration, astigmatism, and distortion aberration are graphs for light in wavelength bands of about 486 nm, about 587 nm, and about 656 nm. In the aberration diagram of FIG. 12, it may be interpreted that the closer each curve is to the Y-axis, the better the aberration correction function, and referring to FIG. 12, it may be seen that measurement values of the optical system 1000 according to the embodiment are adjacent to the Y-axis in most regions. That is, the optical system 1000 according to the third embodiment has improved resolution and may have good optical performance in the center and periphery portions of the FOV.

TABLE 22

| | First | | Second | | Third | |
|---|---|---|---|---|---|---|
| Items | embodiment | | embodiment | | embodiment | |
| F | 5.7 | mm | 5.699 | mm | 5.647 | mm |
| f1 | 56.811 | mm | 48.524 | mm | 58.152 | mm |
| f2 | 4.804 | mm | 4.925 | mm | 4.955 | mm |
| f3 | −6.571 | mm | −6.625 | mm | −6.740 | mm |
| f4 | 27.601 | mm | 22.912 | mm | 23.155 | mm |
| f5 | 12.070 | mm | 11.828 | mm | 10.275 | mm |
| f6 | −9.701 | mm | −9.490 | mm | −9.222 | mm |
| f7 | 3.501 | mm | 3.267 | mm | 3.150 | mm |
| f8 | −7.149 | mm | −5.935 | mm | −5.542 | mm |
| f9 | −5.755 | mm | −5.922 | mm | −5.917 | mm |
| f_G1 | 56.815 | mm | 48.524 | mm | 58.152 | mm |
| f_G2 | 6.249 | mm | 6.355 | mm | 6.061 | mm |
| L1_ET | 0.287 | mm | 0.301 | mm | 0.303 | mm |
| L2_ET | 0.222 | mm | 0.260 | mm | 0.300 | mm |
| L3_ET | 0.612 | mm | 0.620 | mm | 0.621 | mm |
| L4_ET | 0.408 | mm | 0.330 | mm | 0.315 | mm |
| L5_ET | 0.344 | mm | 0.307 | mm | 0.312 | mm |
| L6_ET | 0.456 | mm | 0.482 | mm | 0.558 | mm |
| L7_ET | 0.260 | mm | 0.287 | mm | 0.300 | mm |
| L8_ET | 0.778 | mm | 0.832 | mm | 0.865 | mm |
| L9_ET | 1.026 | mm | 0.947 | mm | 0.860 | mm |
| d12_ET | 0.325 | mm | 0.261 | mm | 0.191 | mm |
| d23_ET | 0.262 | mm | 0.283 | mm | 0.284 | mm |
| d34_ET | −0.007 | mm | −0.004 | mm | 0.030 | mm |
| d45_ET | 0.463 | mm | 0.490 | mm | 0.435 | mm |
| d56_ET | 0.087 | mm | 0.124 | mm | 0.123 | mm |
| d67_ET | 0.335 | mm | 0.355 | mm | 0.364 | mm |
| d78_ET | 0.244 | mm | 0.172 | mm | 0.167 | mm |
| d89_ET | 0.309 | mm | 0.232 | mm | 0.322 | mm |
| L9S2 Inflection | 0.53 | | 0.51 | | 0.5 | |
| point | | | | | | |
| CA_max | 7.655 | mm | 7.559 | mm | 7.636 | mm |
| CA_min | 3.000 | mm | 3.200 | mm | 3.400 | mm |
| CA_Aver | 4.337 | mm | 4.444 | mm | 4.535 | mm |
| L_CT_max | 0.906 | mm | 0.928 | mm | 0.927 | mm |
| L_CT_min | 0.260 | mm | 0.280 | mm | 0.300 | mm |
| L_CT_Aver | 0.516 | mm | 0.510 | mm | 0.516 | mm |
| d89_min | 0.0347 | mm | 0.0281 | mm | 0.0287 | mm |
| L9S2_max_{—} | 0.890 | mm | 0.889 | mm | 0.889 | mm |
| sag to Sensor | | | | | | |
| ΣL_CT | 4.642 | mm | 4.594 | mm | 4.643 | mm |
| ΣAir_CT | 2.126 | mm | 2.147 | mm | 2.075 | mm |
| ΣIndex | 15.083 | | 15.154 | | 15.083 | |
| ΣAbbe | 446.550 | | 408.900 | | 446.550 | |
| TTL | 7.948 | mm | 7.898 | mm | 7.864 | mm |
| BFL | 1.180 | mm | 1.157 | mm | 1.146 | mm |
| ImgH | 4.515 | mm | 4.515 | mm | 4.515 | mm |
| F-number | 1.959 | | 1.722 | | 1.628 | |
| FOV | 76.5 | degree | 76.52 | degree | 77.02 | degree |
| EPD | 2.910 | mm | 3.309 | mm | 3.470 | mm |

TABLE 23

| Equation | | First embodiment | Second embodiment | Third embodiment |
|---|---|---|---|---|
| 1 | 1 < L1_CT/L3_CT < 5 | 1.425 | 1.723 | 1.638 |
| 2 | 1 < L1_CT/L1_ET < 2 | 1.518 | 1.601 | 1.621 |
| 3 | 0.1 < L7_ET/L7_CT < 1 | 0.287 | 0.309 | 0.324 |
| 4 | 0.2 < L8_CT/L8_ET < 1 | 0.629 | 0.464 | 0.347 |
| 5 | 1 < L9_ET/L9_CT < 4 | 2.072 | 1.939 | 1.803 |
| 6 | 1.6 < n3 | Satisfaction | Satisfaction | Satisfaction |
| 7 | 1 < CA_L1S1/CA_L2S1 < 2 | 1.020 | 1.055 | 1.068 |
| 8 | 1 < CA_L9S2/CA_L2S2 < 5 | 2.444 | 2.210 | 2.183 |
| 9 | 0.1 < d23_CT/d23_ET < 1 | 0.381 | 0.353 | 0.353 |
| 10 | 0.3 < L9S2 Inflection point < 0.8 | 0.530 | 0.510 | 0.500 |
| 11 | 0.5 < L1_CT/L2_CT < 0.78 | 0.690 | 0.699 | 0.665 |
| 12 | 1.4 < L7_CT/L8_CT < 3.5 | 1.851 | 2.404 | 3.089 |
| 13 | 1 < L7_CT/L9_CT < 3 | 1.830 | 1.899 | 1.942 |
| 14 | 1 < L1_CT/d12_CT < 5 | 1.641 | 2.084 | 2.615 |
| 15 | 1 < L2_CT/d12_CT < 7 | 2.378 | 2.980 | 3.934 |
| 16 | 1 < L4_CT/d45_CT < 2.5 | 1.821 | 1.693 | 2.060 |
| 17 | 0.2 < d12_CT/d89_CT < 1 | 0.649 | 0.542 | 0.440 |
| 18 | 0.85 < L1_CT/L9_CT < 1.8 | 0.890 | 1.250 | 1.638 |
| 19 | 5 < L7_CT/d78_CT < 16 | 9.056 | 9.276 | 9.267 |
| 20 | 2.2 < L7_CT/d67_CT < 10 | 2.821 | 2.956 | 2.640 |
| 21 | 7 < f1/f2 < 13.5 | 11.827 | 9.853 | 11.736 |
| 22 | −2 < f3/f2 < −0.5 | −1.368 | −1.345 | −1.360 |
| 23 | −1 < f7/f8 < −0.4 | −0.490 | −0.550 | −0.568 |
| 24 | 5 < f_G1/F < 12 | 9.968 | 8.514 | 10.298 |
| 25 | f_G1 > 0f_G2 > 0 | Satisfaction | Satisfaction | Satisfaction |
| 26 | 5 < f_G1/f_G2 < 20 | 9.092 | 7.635 | 9.595 |
| 27 | 1 < CA_max/CA_Aver < 2.5 | 1.765 | 1.701 | 1.684 |
| 28 | 0.5 < CA_min/CA_Aver < 1 | 0.692 | 0.720 | 0.750 |
| 29 | 1.5 < CA_max/CA_min < 3 | 2.552 | 2.362 | 2.246 |
| 30 | 1 < L_CT_max/L_CT_Aver < 2.5 | 1.756 | 1.817 | 1.796 |
| 31 | 0.35 < L_CT_min/L_CT_Aver < 1 | 0.504 | 0.549 | 0.581 |
| 32 | 0.5 < CA_max/(2*ImgH) < 1 | 0.848 | 0.837 | 0.846 |
| 33 | 1 < d89_CT/d89_min < 20 | 11.787 | 15.194 | 14.882 |
| 34 | 0 < L_CT_max/Air_max < 3 | 2.214 | 2.106 | 1.985 |
| 35 | 1 < ΣL_CT/ΣAir_CT < 5 | 2.183 | 2.140 | 2.238 |
| 36 | 10 < ΣIndex < 30 | 15.083 | 15.154 | 14.862 |
| 37 | 10 < ΣAbbe/ΣIndex < 50 | 29.606 | 26.983 | 26.627 |
| 38 | 0.5 < L9S2_max_sag to Sensor < 2 | 0.890 | 0.889 | 0.889 |
| 39 | 2 < TTL < 20 | Satisfaction | Satisfaction | Satisfaction |
| 40 | 2 < ImgH | Satisfaction | Satisfaction | Satisfaction |
| 41 | BFL < 2.5 | Satisfaction | Satisfaction | Satisfaction |
| 42 | FOV < 120 | Satisfaction | Satisfaction | Satisfaction |
| 43 | 0.5 < TTL/ImgH < 2 | 1.761 | 1.749 | 1.742 |
| 44 | 0.1 < BFL/ImgH < 0.5 | 0.261 | 0.256 | 0.254 |
| 45 | 4 < TTL/BFL < 10 | 6.736 | 6.827 | 6.863 |
| 46 | 0.1 < F/TTL < 1 | 0.717 | 0.722 | 0.718 |
| 47 | 3 < F/BFL < 8 | 4.830 | 4.926 | 4.928 |
| 48 | 1 < F/ImgH < 3 | 1.263 | 1.262 | 1.251 |

Table 22 relates to the items of the above-described equations in the optical system 1000 according to the first to third embodiments, and relates to the total track length (TTL), back focal length (BFL), and F value of the optical system 1000, ImgH, the focal lengths f1, f2, f3, f4, f5, f6, f7, f8, and f9, edge thickness (ET), etc. Here, the edge thickness of the lens means the thickness in the optical axis OA direction at the end of the effective region of the lens. In detail, the edge thickness of the lens means the distance in the optical axis OA direction from the end of the effective region on the object-side surface of the lens to the end of the effective region on the sensor-side surface. Table 23 relates to the result values of Equations 1 to 48 described above in the optical system 1000 according to the first to third embodiments. Referring to Table 23, it may be seen that the optical system 1000 according to the first to third embodiments satisfies at least one of Equations 1 to 48. In detail, it may be seen that the optical system 1000 according to the first to third embodiments satisfies all of Equations 1 to 48 above. Accordingly, the optical system 1000 according to the first to third embodiments may have good optical performance in the center and periphery portions of the FOV and may have excellent optical characteristics.

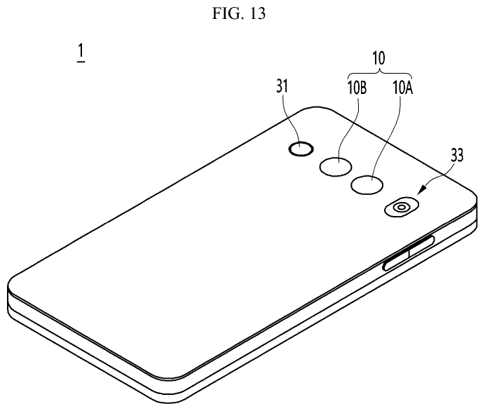

FIG. 13 is a diagram illustrating that a camera module according to an embodiment is applied to a mobile terminal.

Referring to FIG. 13, the mobile terminal 1 may include a camera module 10 provided on the rear side. The camera module 10 may include an image capturing function. In addition, the camera module 10 may include at least one of an autofocus function, a zoom function, and an OIS function. The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

The mobile terminal 1 may further include an autofocus device 31. The autofocus device 31 may include an autofocus function using a laser. The autofocus device 31 may be mainly used in a condition in which an autofocus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy. The mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. Although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1. An optical system comprising:
first to ninth lenses disposed along an optical axis from an object side toward a sensor side,
wherein the first lens has positive (+) refractive power on the optical axis,
wherein the seventh lens has positive (+) refractive power on the optical axis,
wherein an object-side surface and a sensor-side surface of the seventh lens have a convex shape on the optical axis,
wherein the ninth lens has negative (−) refractive power on the optical axis, and
wherein the seventh lens is thickest among thicknesses of each of the first to ninth lenses in the optical axis.

2. The optical system of claim 1, wherein L7_CT is a thickness of the seventh lens in the optical axis,
L7_ET is a distance in an optical axis direction between an end of an effective region of the object-side surface of the seventh lens and an end of an effective region of the sensor-side surface of the seventh lens,
wherein the following equation satisfies:
$$0 < L7\_ET / L7\_CT < 1. \qquad Equation$$

3. (canceled)

4. The optical system of claim 1, wherein the seventh lens has a refractive index greater than 1.6.

5. The optical system of claim 1, wherein the first lens or the third lens has a smallest effective diameter (clear aperture) among the first to ninth lenses.

6. The optical system of claim 1, wherein a sensor-side surface of the first lens serves as an aperture stop.

7. An optical system comprising:
first to ninth lenses disposed along an optical axis from an object side toward a sensor side,
wherein the first lens has positive (+) refractive power on the optical axis,
wherein the seventh lens has positive (+) refractive power on the optical axis,
wherein an object-side surface and a sensor-side surface of the seventh lens have a convex shape on the optical axis,
wherein the ninth lens has negative (−) refractive power on the optical axis,
wherein L7_CT is a thickness of the seventh lens in the optical axis,
wherein L9_CT is a thickness of the ninth lens in the optical axis, and
wherein the following equation satisfies:
$$1 < L7\_CT / L9\_CT < 3. \qquad Equation$$

8. The optical system of claim 7, wherein the seventh lens is a thickest among thicknesses of each of the first to ninth lenses in the optical axis.

9. The optical system of claim 7, wherein L8_CT is a thickness of the eighth lens in the optical axis,
L8_ET is a distance in an optical axis direction between an end of an effective region of an object-side surface of the eighth lens and an end of an effective region of a sensor-side surface of the eighth lens,
wherein the following equation satisfies:
$$0.2 < L8\_CT / L8\_ET < 1. \qquad Equation$$

10. The optical system of to claim 7, wherein an object-side surface of the eighth lens has a concave shape.

11. The optical system of claim 7, wherein L7_CT is the thickness of the seventh lens in the optical axis,
wherein L8_CT is the thickness of the eighth lens in the optical axis,
wherein the following equation satisfies:
$$1. 4 < L7\_CT / L8\_CT < 3.5 . \qquad Equation$$

12. The optical system of claim 7, wherein when the optical axis is a starting point and an end of the effective region of the sensor-side surface of the seventh lens is an end point, a distance in an optical axis direction between the seventh and eighth lenses:
increases from the optical axis to a seventh point located on a sensor-side surface of the seventh lens, and
decreases from the seventh point to an eighth point located on the sensor-side surface of the seventh lens,
wherein the eighth point is the end of the effective region of the sensor-side surface of the seventh lens, and
wherein the seventh point is disposed at a position that is 60% to 90% of an effective radius of the sensor-side surface of the seventh lens.

13. The optical system of claim 7, wherein when the optical axis is a starting point and an end of an effective region of a sensor-side surface of the seventh lens is an end point, a distance in an optical axis direction between the seventh and eighth lenses:
increases from the optical axis to a seventh point located on the sensor-side surface of the seventh lens,
decreases from the seventh point to an eighth point located on the sensor-side surface of the seventh lens, and
decreases from the eighth point to a ninth point located on the sensor-side surface of the seventh lens,
wherein the ninth point is the end of the effective region on the sensor-side surface of the seventh lens,
wherein the seventh point is located at a position that is 50% to 70% of an effective radius of the sensor-side surface of the seventh lens with respect to the optical axis, and wherein the eighth point is located at a position that is 80% to 95% of the effective radius of the sensor-side surface of the seventh lens.

14. An optical system comprising:
first to ninth lenses disposed along an optical axis from an object side toward a sensor side; and
an aperture stop disposed between the first and second lenses,
wherein the first lens is defined as a first lens group,
wherein the second to ninth lenses are defined as a second lens group, and
wherein a focal length of each of the first lens group and the second lens group has a positive value.

15. The optical system of claim 14, wherein f_G1 is a focal length of the first lens group,
wherein f_G2 is a focal length of the second lens group,
wherein the seventh lens is thickest among thicknesses of each of the first to ninth lenses in the optical axis, and
wherein the following equation satisfies:
$$5 < f\_G1 / f\_G2 < 20 . \qquad Equation$$

16. The optical system of claim 14, wherein an object-side surface and a sensor-side surface of the seventh lens have a convex shape on the optical axis.

17. The optical system of claim 14, wherein an object-side surface of the fourth lens has a convex shape on the optical axis,
wherein a sensor-side surface of the fourth lens has a concave shape on the optical axis.

18. The optical system of claim 14, wherein the fifth lens has positive refractive power on the optical axis.

19. The optical system of claim 1, wherein an object-side surface of the fourth lens has a convex shape on the optical axis,
wherein a sensor-side of the fourth lens has a concave shape on the optical axis,
wherein each of the fourth and fifth lenses has positive refractive power on the optical axis.

20. The optical system of claim 1, wherein the first lens disposed between an object and an aperture stop is defined as a first lens group,
wherein a focal length of the first lens group is f_G1,
wherein a focal length of the optical system is F,
wherein the following equation satisfies:
$$5 < f\_G1 / F < 12 . \qquad Equation$$

21. The optical system of claim 20,
wherein the second to ninth lenses disposed between the aperture stop and an image sensor are defined as a second lens group,
wherein a focal length of each of the first and second lens groups has a positive value.
